(19) United States
(12) Patent Application Publication
(10) Pub. No.: US 2018/0056488 A1
(43) Pub. Date: Mar. 1, 2018

(54) A Reversible Wrench

(71) Applicant: Kevin Dein, Dubbo (AU)

(72) Inventor: Kevin Dein, Dubbo (AU)

(21) Appl. No.: 15/558,561

(22) PCT Filed: Mar. 16, 2016
(86) PCT No.: PCT/AU2016/050188

§ 371 Date: Sep. 15, 2017

(30) Foreign Application Priority Data
Mar. 16, 2015 (AU) 2015900988
Jul. 29, 2015 (AU) 2015903021

(51) Int. Cl. B25B 13/46; B25B 23/00; B25B 23/16; F16D 41/08

(52) U.S. Cl. CPC B25B 13/462; F16D 41/086; B25B 23/16; B25B 23/0035

(57) ABSTRACT

A reversible wrench includes a handle and a carrier arranged on the handle. A torque transmission assembly is arranged in the carrier. The assembly includes an inner driven member having an inner, outwardly facing bearing surface and an outer driving member having an outer, inwardly facing bearing surface, the driven and driving members being arranged in the carrier about a common rotation axis and the surfaces being spaced from each other. A selector is positioned between the bearing surfaces. At least one motion transfer device is positioned between the bearing surfaces. The bearing surfaces, the selector and the at least one motion transfer device define at least two roller bearing passages. At least one roller bearing is positioned in each passage. The roller bearings can be shifted between a tightening condition in which the roller bearings lock the bearing members together for tightening rotation of the carrier and a loosening condition in which the roller bearings lock the bearing members together for loosening rotation of the carrier. Opposite rotation of the carrier with respect to the tightening and the loosening rotation, respectively, unlocks the roller bearings to permit freewheeling of the carrier during the opposite rotation. The selector and the at least one motion transfer device are configured so that the selector is operable to shift the roller bearings between the tightening and loosening conditions, via the at least one motion transfer device. A biasing mechanism is operatively arranged with respect to the roller bearings so that the roller bearings are unlocked against a bias of the biasing mechanism during the opposite rotation and are driven back into one of the tightening and loosening conditions upon ceasing of the opposite rotation.

### FIELD

Various exemplary embodiments of reversible wrenches are described herein. Various exemplary embodiments of torque transmission assemblies suitable for reversible wrenches are also described herein. Also described herein are various exemplary embodiments of reversible wrenches that incorporate such torque transmission assemblies.

### SUMMARY

Various exemplary embodiments of a reversible wrench comprise

a handle;

a carrier arranged on the handle; and

a torque transmission assembly arranged in the carrier, the assembly including

an inner driven member having an inner, outwardly facing bearing surface and an outer driving member having an outer, inwardly facing bearing surface, the driven and driving members being arranged in the carrier about a common rotation axis and the surfaces being spaced from each other;

a selector positioned between the bearing surfaces;

at least one motion transfer device positioned between the bearing surfaces, the bearing surfaces, the selector and the at least one motion transfer device defining at least two roller bearing passages;

at least one roller bearing positioned in each passage, the bearing surfaces of each passage being profiled so that the roller bearings can be shifted between a tightening condition in which the roller bearings lock the bearing members together for tightening rotation of the carrier and a loosening condition in which the roller bearings lock the bearing members together for loosening rotation of the carrier and such that opposite rotation of the carrier with respect to the tightening and the loosening rotation, respectively, unlocks the roller bearings to permit freewheeling of the carrier with respect to the inner driving member during the opposite rotation; and

the selector and the at least one motion transfer device are configured so that the selector is operable to shift the roller bearings between the tightening and loosening conditions, via the at least one motion transfer device, a biasing mechanism being operatively arranged with respect to the roller bearings and configured so that the roller bearings are unlocked against a bias of the biasing mechanism during the opposite rotation and are driven back into one of the tightening and loosening conditions upon ceasing of the opposite rotation.

The selector may include a shifting member that is interposed between two passages and displaceable in clockwise and anticlockwise directions, the biasing mechanism being arranged on the shifting member.

The biasing mechanism may include a spring arranged on each side of the shifting member to bear against a roller bearing in each of the two passages such that displacement of the shifting member in either a clockwise or an anticlockwise direction results in the roller bearings being shifted into the tightening or loosening conditions.

The, or each, motion transfer device may include a spacer that is configured to fit between the bearing surfaces and that is shaped so that movement of the spacer as a result of operation of the selector is stabilised.

The, or each, spacer may be configured to act on adjacent roller bearings, while maintaining the roller bearings in a position in which rotational axes of the roller bearings are substantially parallel to the common axis of rotation of the inner and outer bearing members.

The, or each, spacer may include a spacer block having an arcuate cross section to accommodate arcuate, reciprocal movement of the spacer block between the inner and outer bearing member surfaces.

The, or each, spacer may include a biasing mechanism that is arranged on each axial side of the spacer block, the biasing mechanism of the selector being configured to act on the adjacent roller bearings, together with the biasing mechanism of the selector to facilitate maintenance of the roller bearings and the, or each, spacer, in a contiguous relationship.

The biasing mechanism may include at least one spring arranged on each side of the spacer block to act on the adjacent roller bearings.

The plurality of roller bearings may have a varying diameter from a largest to a smallest, and may be positioned, in decreasing size order, in at least one respective passage. At least one of the bearing surfaces of the at least one respective passage may define at least one involute plan profile with reference to the common rotation axis and the at least one involute plan profile may be configured such that the plurality of roller bearings can shift into a tightening or loosening condition in which the roller bearings engage each other and the inner and outer bearing surfaces.

The inner bearing surface may be circular cylindrical and the outer bearing surface may define the at least one involute plan profile.

The bearing surfaces, the selector and the motion transfer devices may define three circumferential roller bearing passages, in the form of a left-hand passage, a right-hand passage and an intermediate passage, when viewed proximally, the intermediate passage being interposed between the left and right hand passages.

The left and right hand passages may each have the plurality of roller bearings and the at least one involute plan profile, with the left and right hand passages being symmetrical so that the roller bearings in one of the left and right hand passages can move into the tightening or loosening condition while the bearings in another of the left and right hand passages can move out of the tightening or loosening condition. The intermediate passage may contain or have at least one roller bearing capable of shifting between the tightening and loosening conditions in the intermediate passage.

The bearing surfaces may be profiled so that a largest bearing in each of the left and right passages is capable of seating in a respective end of the left and right passages so that, during the opposite rotation, the largest bearings can rotate, roller bearing fashion, in the respective left and right passages.

The bearings in the intermediate passage may include an odd number of bearings with a middle, largest bearing and the bearing surfaces of the intermediate passage may be configured so that the middle largest bearing can rotate, in a conventional roller bearing fashion, during the opposite rotation.

The bearing surfaces, the selector and the motion transfer devices may define two circumferential roller bearing passages, in the form of a left-hand passage and a right-hand passage, when viewed proximally.

The left and right hand passages may each have the plurality of roller bearings and the at least one involute plan profile with the left and right hand passages being symmetrical so that the roller bearings in one of the left and right hand passages move into a tightening or loosening condition while the bearings in another of the left and right hand passages move out of a tightening or loosening condition.

The bearing surfaces may be profiled so that a largest bearing in each of the left and right passages is capable of seating in a respective end of the left and right passages so that, during the opposite rotation, the largest bearings can rotate, roller bearing fashion, in the respective left and right passages.

The bearing surfaces of at least one passage may be profiled so that at least two roller bearings of substantially equal diameter can be received in the at least one passage and so that the roller bearings can be shifted between the tightening and loosening conditions.

The bearing surfaces of the at least one passage may be profiled so that the roller bearings can shift a predetermined extent between a position in which the roller bearings are contiguous and centrally positioned in the at least one passage and a position in which the roller bearings are in either of the tightening and loosening conditions.

The inner driven member may be a hub capable of engagement with a socket adaptor so that rotation of the hub can result in rotation of the socket adaptor.

The driving member may be a cup member with a cup wall that defines the outer bearing surface.

The driving member and the carrier may be in the form of a unitary, one-piece construction.

The driving member and the carrier may be configured so that the driving member can be mounted in the carrier.

The driving member and the carrier may be configured so that the driving member can be press-fitted into the carrier. The carrier and the driving member may have corresponding non-circular profiles to inhibit relative rotation of the carrier and the driving member.

The handle and the carrier ma of a one-piece, unitary construction of one material and the torque transmission assembly are of a different material.

The handle and the carrier may be of one of an aluminium alloy and an anodised aluminium, and the torque transmission assembly may be of steel.

Various exemplary embodiments of a torque transmission assembly comprise

an inner driven member having an inner, outwardly facing bearing surface and an outer driving member having an outer, inwardly facing bearing surfaces, the driven and driving members being configured for mounting in a suitable carrier, about a common rotation axis, the surfaces being spaced from each other;

a selector positioned between the bearing surfaces;

at least one motion transfer device positioned between the bearing surfaces, the bearing surfaces, the selector and the at least one motion transfer device defining at least two roller bearing passages;

at least one roller bearing positioned in each passage, the bearing surfaces of each passage being profiled so that the roller bearings can be shifted between a tightening condition in which the roller bearings lock the bearing members together for tightening rotation of the carrier and a loosening condition in which the roller bearings lock the bearing members together for loosening rotation of the carrier and such that opposite rotation of the carrier with respect to the tightening and the loosening rotation, respectively, unlocks the roller bearings to permit freewheeling of the carrier during the opposite rotation; and

the selector and the at least one motion transfer device are configured so that the selector is operable to shift the roller bearings between the tightening and loosening conditions, via the at least one motion transfer device, a biasing mechanism being operatively arranged with respect to the roller bearings and configured so that the roller bearings are unlocked against a bias of the biasing mechanism during the opposite rotation and are driven back into one of the tightening and loosening conditions upon ceasing of the opposite rotation.

### DESCRIPTION OF THE DRAWINGS

FIG. 1 shows side and bottom views of an exemplary embodiment of a reversible wrench.

FIG. 2 shows a three dimensional view of the wrench.

FIG. 3 shows a side view of the wrench of FIG. 1.

FIG. 4 shows a diagrammatic plan sectioned view of a head of the wrench taken through C-C in FIG. 3.

FIG. 5 shows a detailed view of the portion A in FIG. 4.

FIG. 6 shows another side view similar to FIG. 3.

FIG. 7 shows a sectional side view, taken through D-D in FIG. 6, of an exemplary embodiment of a torque transmission assembly for a wrench.

FIG. 8 shows exemplary embodiments of a head of the wrench and a socket for use with the wrench.

FIG. 9 shows an exploded view of the wrench.

FIG. 10 shows a partly exploded view of the torque transmission assembly of FIG. 7.

FIG. 11 shows a motion transfer device for the torque transmission assembly.

FIG. 12 shows a spring for a selector of the wrench.

FIG. 13 shows a proximal plan view of the head of the wrench, with a switch in a tightening position for a right hand thread.

FIG. 14 shows a distal, internal view of the torque transmission assembly in a loosening configuration for a right hand thread.

FIG. 15 shows a distal view of a switch for a selector of the wrench.

FIG. 16 shows a sectioned proximal plan view of the torque transmission assembly in a tightening configuration for a right hand thread.

FIG. 17 shows another proximal plan view of the head of the wrench with a switch in a loosening position for a right hand thread.

FIG. 18 shows a distal, internal view of the torque transmission assembly in a tightening configuration for a right hand thread.

FIG. 19 shows a sectioned proximal plan view of the torque transmission assembly in a loosening configuration for a right hand thread.

FIG. 20 shows an exemplary embodiment of a handle for a wrench.

FIG. 21 shows an exploded view of an exemplary embodiment of a reversible wrench.

FIG. 22 shows a sectioned distal view of a torque transmission assembly of the wrench of FIG. 21 in a neutral position.

FIG. 23 shows an exploded view of an exemplary embodiment of a reversible wrench.

FIG. 24 shows a schematic view of a torque transmission assembly of the wrench of FIG. 23.

FIG. 25 shows a schematic, sectioned distal view of a torque transmission assembly of a further embodiment of a reversible wrench.

FIG. 26 shows a plan, schematic view of an exemplary embodiment of a torque transmission assembly of a reversible wrench.

FIG. 27 shows a three dimensional view of a carrier and a cup for the torque transmission assembly of FIG. 26.

FIG. 28 shows a profile of a bearing surface of the cup of FIG. 27 indicating exemplary dimensions.

FIG. 29 shows a side view of the cup of FIG. 27, also indicating exemplary dimensions.

FIG. 30 shows a plan view of part of the embodiment of FIG. 21, indicating exemplary dimensions used to achieve a desired extent of switch movement.

FIG. 31 shows an exploded, perspective view of an exemplary embodiment of a wrench.

FIG. 32 shows another exploded, perspective view, from a different side, of the wrench of FIG. 31.

FIG. 32A shows a detailed view of the part “A” in FIG. 31.

FIG. 33 is a sectioned view along “Y-Y” in FIG. 35.

FIG. 34 is a sectioned view along “X-X” in FIG. 35.

FIG. 35 is an end view of the wrench shown in FIGS. 31 and 32.

FIG. 36 is a view similar to FIG. 34, but shows an external socket inserted into an opposite side of the wrench.

FIG. 37 is a view similar to FIG. 34 with the external socket inserted into an opposite side of the wrench.

FIGS. 38 to 40 show a sequence of movements when a drive member is pushed through the wrench from one side of the wrench to the other to reverse a drive direction.

FIG. 41 shows a perspective view of the external socket.

FIG. 42 shows a perspective view of a head of the wrench with the drive member extending outwardly therefrom.

FIG. 43 shows the wrench, with components removed to indicate a torque transmission assembly of the wrench.

FIG. 44 shows detail of the torque transmission assembly.

FIG. 45 shows detail of the area “C” in FIG. 44.

FIG. 46 shows a similar view to that shown in FIG. 43, with the torque transmission assembly in a “freewheeling” or opposite rotational mode to reset the torque transmission assembly.

FIG. 47 shows detail of the torque transmission assembly of FIG. 46.

FIG. 48 shows detail of the area “C” in FIG. 47.

FIG. 49 shows an exemplary embodiment of part of a wrench.

FIG. 50 shows an exploded view of the wrench of FIG. 49.

FIG. 51 shows an exploded perspective view of an exemplary embodiment of a slogging wrench.

FIG. 52 shows a further exploded perspective view of the slogging wrench of FIG. 51.

FIG. 53 shows a proximal view of the slogging wrench of FIGS. 51 and 52.

FIG. 54 shows a side view of the slogging wrench of FIGS. 51 and 52.

FIG. 55 shows a sectioned side view through “A-A” in FIG. 53.

FIG. 56 shows a perspective view of the slogging wrench of FIG. 53.

FIG. 57 is a section through line “B-B” in FIG. 54.

FIG. 58 is a perspective view of a multipurpose (slide hammer operated) dual end percussion tool coupled with the slogging wrench of FIG. 53.

FIG. 59 is a perspective view of the slogging wrench coupled below a striking plate of the dual end percussion tool.

FIG. 60 shows a lever member, shown in FIG. 62, replacing the slogging wrench in the multipurpose dual end percussion tool.

FIG. 61 shows a further view of the arrangement in FIG. 60.

FIG. 62 is a perspective view of a lever member for the percussion tool.

FIG. 63 shows a perspective view of another example of a lever member.

FIG. 64 shows a head of the lever member of FIG. 63.

FIG. 65 shows an impact socket turning apparatus connected to the lever member of FIG. 63.

FIG. 66 shows an exploded perspective view of the impact socket turning apparatus of FIG. 65.

FIG. 67 shows another exploded perspective view of the impact socket turning apparatus of FIG. 65.

FIG. 68 shows a slide hammer drawn in phantom positioned in the multipurpose dual end percussion tool and connected with the impact socket turning apparatus, with the impact socket turning apparatus also shown connected with the lever member of FIG. 63.

FIG. 69 shows detail of the portion D in FIG. 68.

FIG. 70 shows a view of the multipurpose, dual-end percussion tool connected with a lever member.

FIG. 71 shows a view of a lever member for the tool shown in FIG. 70.

### DESCRIPTION OF THE EMBODIMENTS

In the drawings, reference numeral 10 refers generally to an exemplary embodiment of a reversible wrench. Broadly, the wrench 10 includes a head 12 and an elongated crank handle 14. The wrench 10 further includes a torque transmission assembly 16.

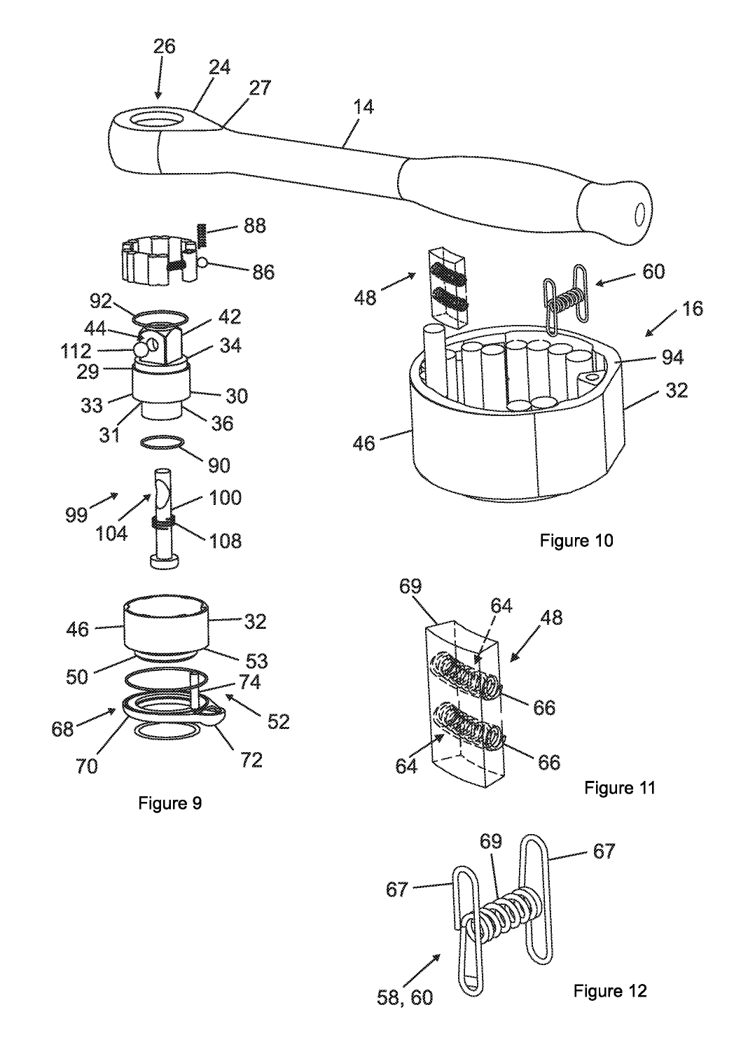

The head 12 includes a generally circular annular cupped formation or carrier 18 that has a circumferentially extending side wall 20, an axially proximal end 22 and an axially opposing, distal annular end wall 24 defining a central circular opening 26 (see FIGS. 7, 9). The carrier 18 transitions radially outwards into the crank handle 14 through a neck 27 that is relatively wider towards the head 12 and relatively narrower towards the crank handle 14.

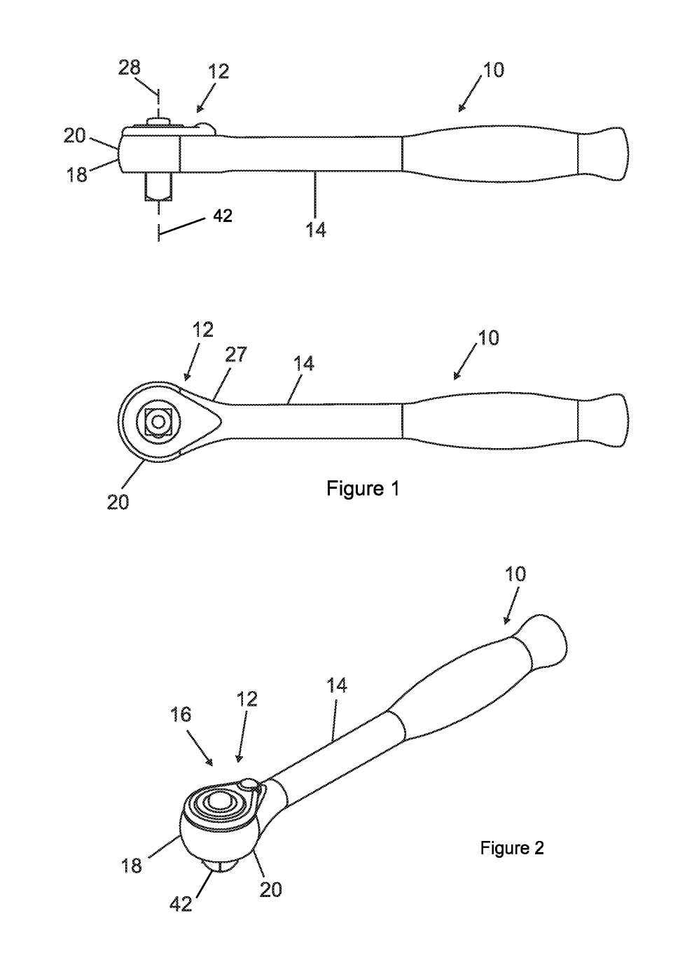

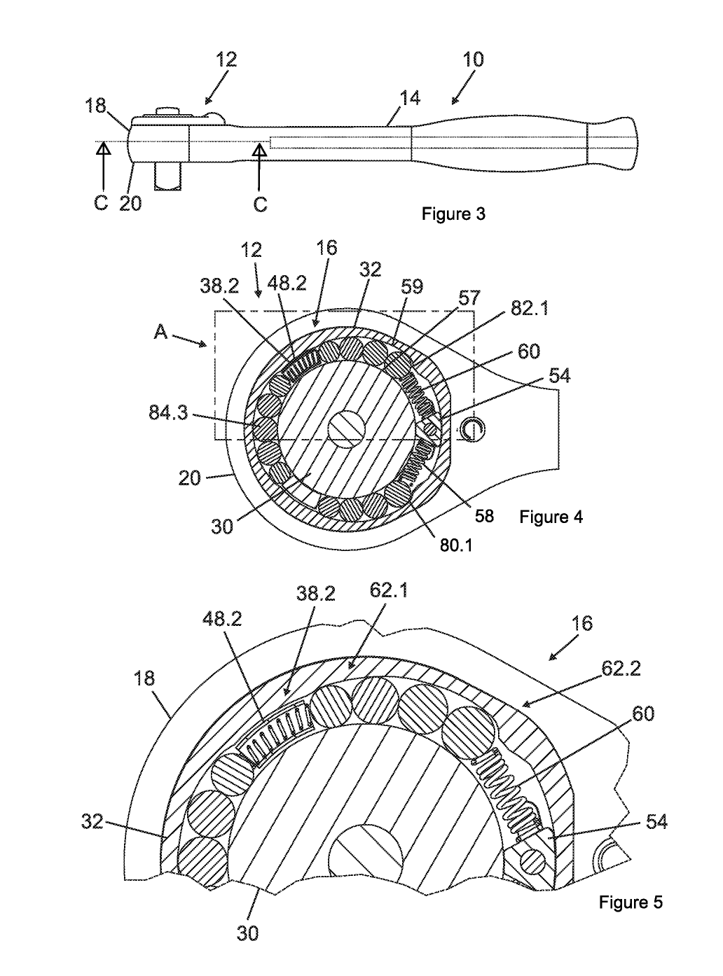

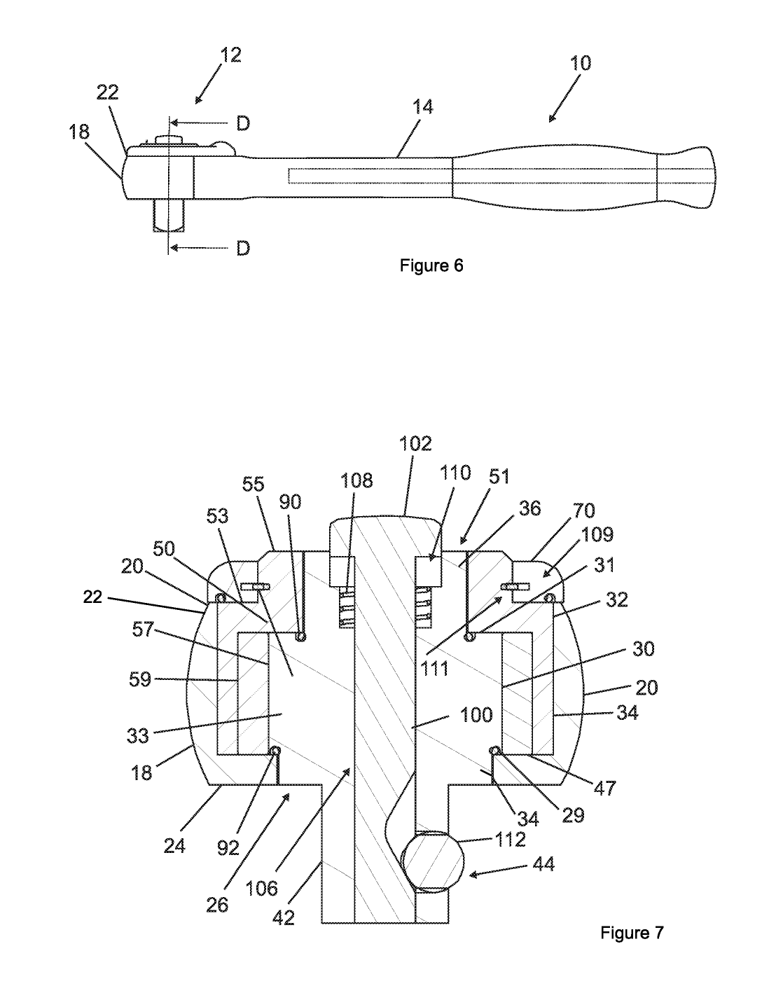

The torque transmission assembly 16 includes an inner driven member or hub 30 and an outer driving or cup member or cup 32 with a radially outer cup wall 46. The hub 30 and the cup 32 are arranged or mounted in the carrier 18, about a common rotation axis 28 that is shown in FIG. 1.

The hub 30 is circular cylindrical and includes an axially central hub formation 33 (FIG. 7), an axially extending, distal end hub formation 34 and an axially extending, proximal end hub formation 36. The end hub formations 34, 36 are both smaller in diameter than the central hub formation 33. Thus, the end hub formations 34, 36 and the central hub formation 33 form an axially, outwardly facing distal shoulder 29 and an axially, outwardly facing proximal shoulder 31 (FIGS. 7 and 9).

A socket adaptor formation, or adaptor 42, is generally square-shaped in cross-section and projects axially away from the end hub formation 34. The adaptor 42 defines a detent ball opening 44 in one of its sides.

The cup 32 is generally circular cylindrical and the cup wall 46 is open at a distal end 47 (see FIG. 14). An annular cup end wall 50 is at a proximal end and defines a circular central opening 51 (FIG. 7). The cup end wall 50 is radially stepped to form an annular shoulder 53 with a narrowed portion 55 extending from the shoulder 53 to receive the hub formation 36.

Orientation and configuration of various components described herein are with reference to a view from above or from the crank handle 14, namely, from an operator's point of view. Furthermore, the term “proximal” and “distal” is also used with reference to the operator's point of view, where “proximal” is closer to the operator than “distal”. It follows that when a proximal side of the wrench engages a bolt or nut with a right-hand thread, clockwise rotation of the wrench results in tightening of the bolt or nut while anticlockwise rotation of the wrench results in loosening of the bolt or nut. Likewise, when referring to positions with reference to the crank handle 14, “proximal” is closer to the crank handle 14 than “distal”.

An inner, outwardly facing bearing surface 57, of the hub 30 and an outer, inwardly facing bearing surface 59 of the cup 32 are radially spaced from each other. The surfaces 57, 59 are profiled to be variably spaced. Further, the surfaces 57, 59, two motion transfer devices (described in further detail below) and a selector (also described in further detail below) define three circumferential roller bearing passages 56 (FIGS. 14, 18). When viewed from a proximal side, these include a left-hand passage 56.1, a right-hand passage 56.2 and an intermediate passage 56.3 interposed between the left and right hand passages 56.1 and 56.2. The left and right hand passages 56.1 and 56.2 are symmetrical about a diametrical axis. The bearing surface 57 of the hub 30 is circular cylindrical.

In the passage 56.1, the surface 59 has a radial profile that defines an involute with reference to the surface 57. The involute can be in various forms, such as an arithmetic spiral or an Archimedean spiral. The radial profile has an increasing radius, measured from a centre point 66 (FIGS. 16 and 19) of the hub 30, from a distal end portion 61.1 of the passage 56.1 to a proximal end portion 61.2 of the passage 56.1. In the passage 56.2, the radial profile of the surface 59 defines an involute with an increasing radius, measured from the centre point 66, from a distal end portion 62.1 of the passage 56.2 to a proximal end portion 62.2 of the passage 56.2. In the passage 56.3, the radial profile defines an involute with a variable radius measured from the centre point 66. The radius increases from a left hand end portion 65.1 of the passage 56.3 to a distal intermediate zone 67 and then decreases from the intermediate zone 67 to a right hand end portion 65.2 of the passage 56.3. See FIG. 16, which has been used to indicate these portions.

It will readily be appreciated that both the surfaces 59, 57 could have radial profiles with suitable curves. Alternatively, the surface 57 could have involutes of a circle with decreasing and increasing radii to provide a similar function to the surface 59.

The proximal end portions 61.1 and 61.2 of the passages 56 are further radiused or profiled so that the proximal end portions 61.2 and 62.2 define seats for respective bearings as described below.

The hub 30 has a circular cross-section. The cup wall 46 and the hub 30 are shaped to partially define the passages 56 and motion transfer gaps 38.1, 38.2 (for example, FIG. 14), between the passage 56.3 and the respective passages 56.1 and 56.2 on each side of the passage 56.3. The cup wall 46 and the hub 30 are also shaped to define a selector space 40. The purpose of these is described in further detail below.

The torque transmission assembly 16 includes gangs or groups of roller bearings 80, 82, 84, confined in the associated passages 56.1, 56.2 and 56.3, respectively.

The gang 80 includes four roller bearings 80.1 to 80.4. The gang 84 includes an odd number, such as five, roller bearings 84.1 to 84.5. The gang 82 includes four roller bearings 82.1 to 82.4.

The roller bearings 80.1 to 80.4 are arranged consecutively in order of decreasing diameter from the proximal end 61.2 to the distal end 61.1. The roller bearings 82.1 to 82.4 are arranged consecutively in order of decreasing diameter from the proximal end 62.2 to the distal end 62.1. The roller bearings 84.1 to 84.5 are arranged with a central or middle roller bearing 84.3, having the largest diameter of all five, and two roller bearings on each side, namely, 84.2 and 84.1, in consecutive decreasing diameter, towards the left-hand side and 84.4 and 84.5, in consecutive decreasing diameter, towards the right-hand side.

The roller bearings 80, 82 and 84 can have the following diameters:

a. Roller bearings 80.1, 82.1 and 84.3: 4.336 mm.

b. Roller bearings 80.2, 82.2, 84.2 and 84.4: 4.020 mm.

c. Roller bearings 80.3, 82.3, 84.1 and 84.5: 3.705 mm

d. Roller bearings 80.4 and 82.4: 3.449 mm

It is to be understood that the dimensions of the roller bearings, as set out above, can determine the profile of the surface 59 such that the spacing between the surfaces 57 and 59 can accommodate the roller bearings.

The relative dimensions of the roller bearings 80 and 82 and the surfaces 57 and 59 in the passages 56.1 and 56.2 are such that the roller bearings 80 and 82 can shift together towards the distal ends 61.1 and 62.1, respectively, into a position in which the roller bearings 80 and 82 nest in the passages 56.1 and 56.2, respectively, with contact points being defined between the roller bearings 80 and 82, themselves, and between the roller bearings 80 and 82 and both the bearing surfaces 57 and 59. Furthermore, the relative dimensions are such that, when the roller bearings 80 and 82 are in that nested condition, frictional engagement is set up substantially equally across the contact points. This serves to lock the surfaces 57, 59 together, wedge-fashion.

The relative dimensions of the roller bearings 84 and the bearing surfaces 57 and 59 in the passage 56.3 are such that the roller bearings 84 can shift together towards a left-hand side, viewed proximally, of the passage 56.3 into a position in which the roller bearings 84.1, 84.2, and 84.3 can nest in the passage 56.3 with contact points being defined between the roller bearings 84.1, 84.2 and 84.3, themselves, and between those roller bearings and both the bearing surfaces 57 and 59, and towards a right-hand side, viewed proximally, of the passage 56.3 into a position in which the roller bearings 84.3, 84.4 and 84.5 can nest in the passage 56.3 with contact points being defined between the roller bearings 84.3, 84.4 and 84.5, themselves, and between those roller bearings and both the bearing surfaces 57 and 59. Furthermore, the relative dimensions are such that, in both cases, when the roller bearings 84 are in the nested conditions, frictional engagement is set up substantially equally across the contact points. As above, this also serves to lock the surfaces together, wedge-fashion.

The roller bearings can each have a length of between about 10 mm and 14 mm, for example, 11.8 mm.

A motion transfer device 48 (see FIG. 11 for detail) is positioned in each motion transfer gap 38. More particularly, a motion transfer device 48.1 is positioned in the gap 38.1 between the passages 56.1 and 56.3, and a motion transfer device 48.2 is positioned in the gap 38.2 between the passages 56.3 and 56.2.

A selector in the form of a selector mechanism or device 52 is positioned in the selector space 40. The selector 52 is configured so that operation of the selector 52 results in the transmission of movement from either of gangs 80, 82, to the other, via the devices 48 and the gang 84.

It will thus be appreciated that the bearing surfaces 57 and 59, the motion transfer devices 48 and the selector 52 defines the passages 56.

The selector 52 incorporates a shifting member or block 54 that is interposed between two passages and displaceable in clockwise and anticlockwise directions. The selector also includes a biasing mechanism, mounted on the shifting member, which is configured so that the rollers are unlocked against a bias of the biasing mechanism during the opposite rotation and are driven back into one of the tightening and loosening conditions upon ceasing of the opposite rotation.

The biasing mechanism of the selector includes a left-hand spring 58 that is interposed between the block 54 and the bearing 80.1. Similarly, a right-hand spring 60 is interposed between the block 54 and the bearing 82.1. The springs 58, 60 serve to set up circumferential compression in the bearings 80, 82, 84, and the motion transfer devices 48 so that the roller bearings 80, 82 and 84 and the motion transfer devices 48 remain contiguous during operation. This also serves to maintain the bearings 80, 82, 84, in an appropriate axial orientation for proper operation.

As can be seen in the drawings, the block 54 extends axially. Thus, the springs 58, 60 are in the form of H-springs or butterfly springs. Detail of one of these can be seen in FIG. 12. The springs 58, 60 have enlarged ends 67 to bear against roller bearings 80.1 and 82.1 and the block 54 in a stable manner, taking into account the length of the bearings 80.1 and 82.1. An intermediate portion 69 interconnects the ends 67. The enlarged ends 67 of the springs 58, 60 are shaped and dimensioned so that they bear against substantial portions of axially extending side faces of the block 54.

The inward bearing surface 59 of the cup wall 47 is circular in radial cross section at the selector space 40. The block 54 is shaped to slide between the cup wall 46 and the hub 30 to and from within the selector space 40. Thus, movement of the block 54 can generate a bias within the bearings and the motion transfer devices in either a clockwise (tightening) or an anticlockwise (loosening) direction when the relevant bearings become frictionally engaged with each other and the surfaces 57, 59, as described above.

The motion transfer devices 48 include spacers having spacer blocks 69 (FIG. 11). These have an axial length that is sufficient to stabilise their movement within the motion transfer gaps 38. For example, they may have an arcuate cross-section that corresponds with a curvature of the surfaces 57 and 59 at the motion transfer gaps 38. This allows the blocks 69 to slide to and fro within the gaps 38 such that movement of the spacers as a result of operation of the selector 52 is stabilised. A biasing mechanism is arranged on each side of each block 69, the biasing mechanisms being configured to act on adjacent roller bearings, together with the biasing mechanism or springs of the selector to facilitate maintenance of the roller bearings and the, or each, spacer, in a contiguous relationship. The blocks 69 each define two passages 64 that each accommodate a compression spring 66, respectively. The compression springs 66 extend from both axial faces of the blocks 69. Thus, the springs 58, 60, 66 maintain compression between the roller bearings during operation and also when the selector 52 is operated, such that the selector 52, the roller bearings 80, 82, 84 and the motion transfer devices 48 remain substantially contiguous both during and after operation. In addition, the springs serve to maintain rotational axes of the roller bearings in a position in which they are substantially parallel to the common axis of rotation of the inner and outer bearing members.

As is seen in, for example FIG. 16, the selector device 52, the block 54, the roller bearings 80, 82, 84 and the motion transfer devices 48 form a closed, single file of contiguous members that circumscribe the hub 30. Furthermore, the use of the butterfly springs 58, 60 facilitates the maintenance of such an arrangement during operation and bias selection.

The torque transmission assembly includes a switch 68 operable on the block 54 of the selector 52 so that operation of the switch 68 can be used to displace the block 54 to and fro, as described above. The switch 68 includes an annular switch formation 70 that transitions into a radial thumb knob 72. A finger 74 (FIG. 15) projects axially away from the annular switch formation 70 from near the thumb knob 72. The finger 74 is shaped and sized to fit snugly into an axial passage 76 defined by the block 54. The thumb knob 72 defines a detent recess 78 for cooperation with a detent ball 86 that is urged towards the switch 68 with a spring 88. In other embodiments, the ball 86 can be in the form of a stub member.

The switch 68 can be of metal. However, the switch 68 can also be of a reinforced plastics material. Such a material has electrical resistance properties. It follows that the switch 68 can contribute to an overall electrical resistance provided by the wrench 10.

A seal, for example, an O-ring 90 (FIGS. 7 and 9), is interposed between the shoulder 31 and the cup end wall 50. A further seal, for example, an O-ring 92, is interposed between the shoulder 29 and the end wall 24 of the head 12. It follows that the moving components of the wrench 10 are encapsulated between the seals 90, 92 so as to seal out dust, dirt, moisture and other contaminants and to seal in lubricants.

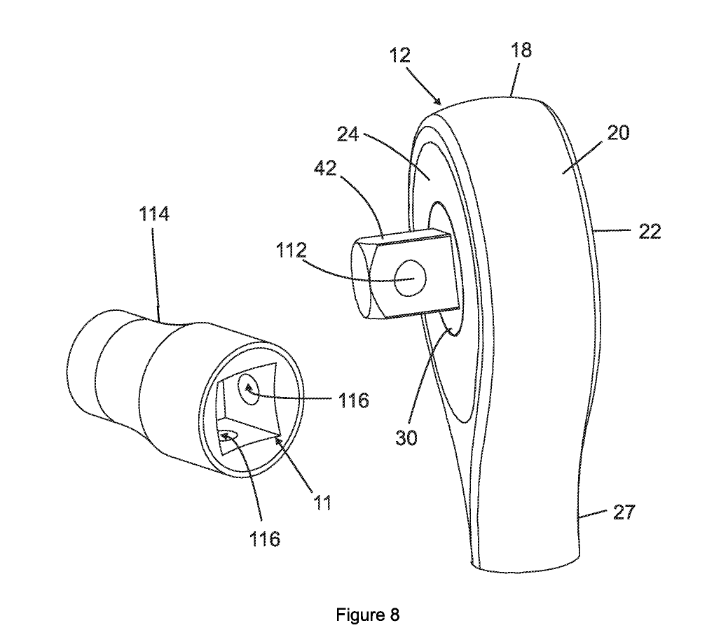

A socket quick release assembly 99 includes a link pin 100 having a head 102 at one end and a transverse detent recess 104 towards its other end (FIG. 9). The hub 30 defines an axial passage 106 (FIG. 7) for receiving the link pin 100. The hub end formation 36 defines a counter sunk portion 110 for receiving the head 102. A spring 108 is mounted in the counter sunk portion 110 for biasing the link pin 100 towards a position in which the detent recess 104 of the link pin 100 urges a detent ball 112 radially away from the link pin 100 thus to connect a socket 114 (FIG. 8) to the adaptor 42.

In this embodiment, the cup 32 is press-fitted into the head 12. Furthermore, the cup 32 can be coined further to lock it in position to inhibit disassembly.

As can be seen in FIG. 7, the narrowed portion 55 and the annular switch formation 70 have complimentary circumferential slots 109, 111, respectively. A circlip 113 is received in the slots 109, 111 to clip the formation 70 to the narrowed portion 55 in a non-removable manner so as to inhibit disassembly of the wrench 10.

In use, broadly, the wrench 10 forms a socket wrench. The adaptor 42 connects to a socket 114 (FIG. 8) by inserting the adaptor 42 into a socket opening 11 of the socket 114. The detent ball 112 interacts with detent recesses 116 in the socket 114 to resist dislodgment of the socket 114 from the adaptor 42.

The selector device 52 enables selection in operation of the wrench 10 either to drive the hub 30, and hence the socket 114, by a driving stroke of the crank handle 14 in one rotational direction and to return with a free stroke in an opposite rotational return or resetting direction, or to drive the hub 30 by a driving stroke of the crank handle 14 in the aforementioned opposite rotational direction and to return with a free stroke in the aforementioned return or resetting direction. The operation of the torque transmission assembly 16 is explained in more detail below.

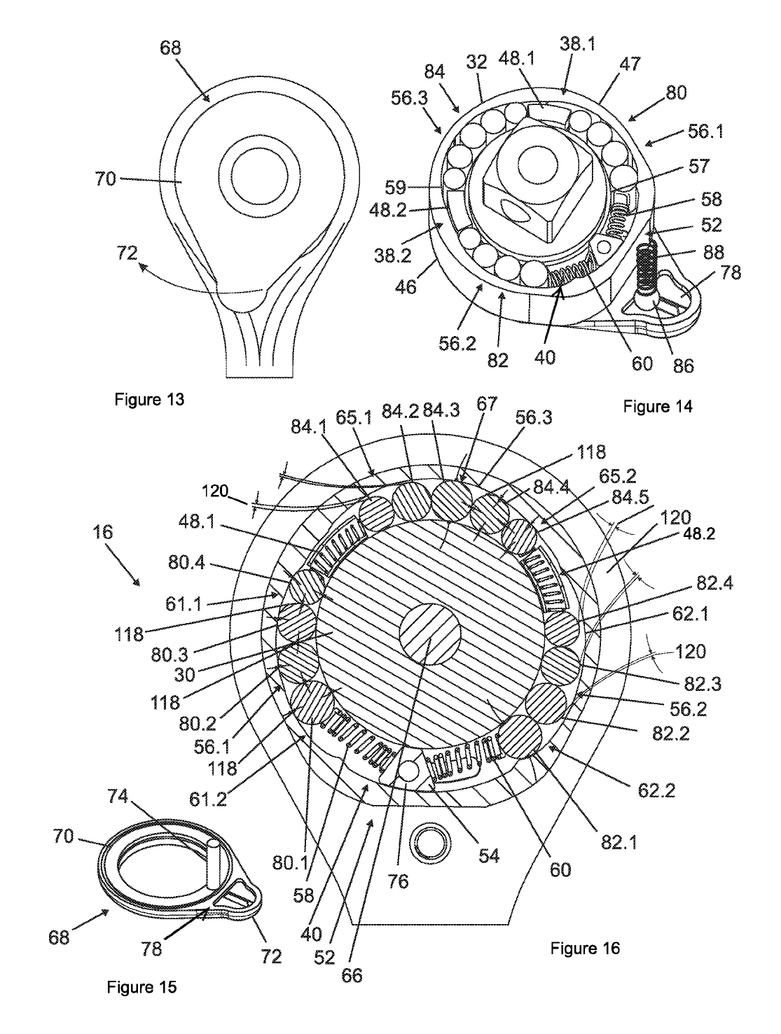

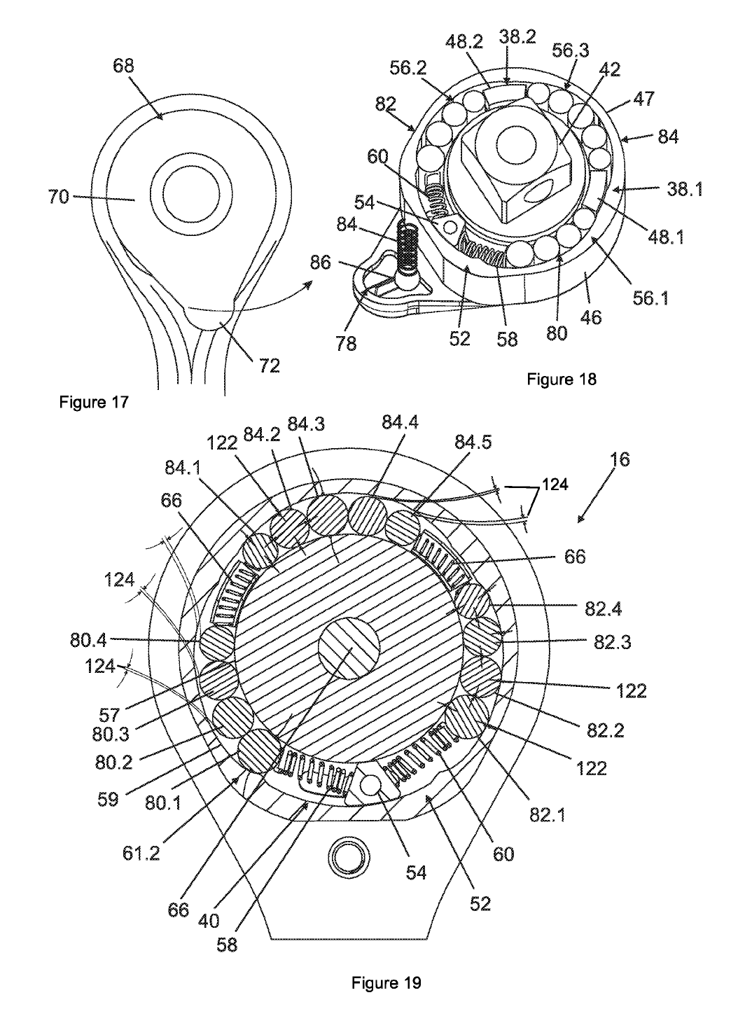

Referring to FIGS. 13 and 16, when it is required to drive the hub 30 in a clockwise direction, the thumb knob 72 is pushed in the clockwise direction or to the left. This causes the finger 74 to shift or slide the block 54 in the clockwise direction until the detent recess 78 registers with the detent ball 86 which keeps the switch formation 70 and hence the block 54 in position relative to the cup 32. That causes the spring 58 to push against the roller bearing member 80.1 of the gang of roller bearing members 80. The springs 58, 60 are engineered and dimensioned so that when one of the springs 58 and 60 is compressed by movement of the block 54, the other of the springs 58 and 60 returns to its relaxed, extended condition.

Since the roller bearings and the transfer devices are contiguous, the entire single file of bearing members and transfer devices are shifted clockwise. Particularly, roller bearings 80.1 to 80.4 and 84.3 to 84.5 are shifted into one locking position or nested configuration, as described above, hereinafter referred to as the clockwise locking position, in which the roller bearings 80 are urged towards the distal end of the passage 56.1 and the roller bearings 84 are urged towards the right hand end of the passage 56.3, both of which are restrictive due to the involute curve of the cup surface 59. At the same time, the roller bearings 82 are urged toward the proximal end of the passage 56.2 so that the bearing 82.1 can seat in the proximal end portion 62.3 in a conventional roller bearing fashion. More particularly, the roller bearings 80, 84 are urged towards the restricted ends of their passages 56.1 and 56.3 while the roller bearings 82 are urged away from the restricted end of their passage 56.2. During this time, the roller bearing 84.3 remains substantially in a roller bearing configuration. Thus, the bearing 84.3 acts as a motion transfer element in both directions.

In this configuration, contact points 118 (FIG. 16) can be seen in the gang 80 and in the bearings 84.3 to 84.5. At these points, the bearings 80.1 to 80.4 are settled in frictional engagement with each other, the hub 30 and the cup 32, as described above. As can be seen, there are eleven locking positions or contact points in that group of bearings. The locking surface area is calculated from the centre of the bearing 80.1 to the centre of the bearing 80.4. At the same time, there is another locking area from the centre of the bearing 84.4 to the centre of the bearing 84.5.

Also, gaps or spaces 120 can be seen between the bearings 84.1, 84.2, 82.2, 82.3, 82.4 and the cup 32.

Moreover, the profile of the cup surface of the cup wall 46 in relation to the bearings 80.1 to 80.4 and 84.3 to 84.5 and the bearing surface of the hub 30 are such that those bearings are received in the restricted passages in a manner that inhibits any further displacement of the bearings in the clockwise direction along the respective passages. It follows that the hub 30 and the cup 32 are effectively locked together, as a result of frictional engagement, in the sense that, when the crank handle 14 is rotated clockwise, no relative movement of the cup 32 and the hub 30 is possible, resulting in the hub 30 being driven by the cup 32 via the frictionally engaged bearings. Thus, the frictionally engaged bearings are in a tightening condition, to allow the wrench 10 to tighten a right-hand threaded fastener.

This is achieved, at least in part, by accurate and consistent machining of the bearings and the bearing surfaces. In addition, a material of the roller bearings is selected to be substantially incompressible during operation of the torque transmission assembly. This has been found to enhance the frictional engagement referred to above.

For example, the material of the roller bearings 80, 82 and 84 and the material of the hub 30 and the cup 32 can have a Rockwell Hardness of between fifty-six and fifty-eight. An example of a suitable material for the bearings is a tool steel, such as silver steel that is hardened to the above Rockwell Hardness.

It is to be appreciated that the roller bearings 80, 82 and 84 and the hub 30 and cup 32 need to be of a similar hardness to avoid wear or pitting of the surfaces 57, 59. Such wear or pitting would reduce the efficacy of operation and, ultimately, result in damage to the mechanism.

Still referring to FIG. 16, when the crank handle 14 is rotated in an anticlockwise, return direction, the bearings 80.1 to 80.4 and 84.3 to 84.5 are disturbed or unsettled by relative movement of the cup 32 and the hub 30. The profiles of the surface 59 in relation to the bearings 80 to 84 and the surface 57 are such that the bearings 80 to 84 are unsettled sufficiently within a relatively small angular displacement of the crank handle, for example, from 0.1 to 0.5 degrees, and sufficiently to enable rolling of the bearings 82.1, 84.3 under influence of the relative rotation of the cup 32 and the hub 30.

During this anti-clockwise movement, the springs 58, 66, the motion transfer devices 48 and the block 54, serve to bias the bearings 80.1 to 80.4 and 84.3 to 84.5 towards the restricted passages albeit in an unsettled condition. That results in the bearings 82.1 and 84.3 being capable of rotation, in conventional roller bearing fashion, such that substantially drag-free rotation of the crank handle 14 in an anticlockwise return direction can occur relative to the hub 30.

Upon ceasing of the free-wheeling anticlockwise rotation, the springs 58, 66 and the motion transfer devices 48 immediately reset the bearings 80.1 to 80.4 and 84.3 to 84.5 into their settled locked condition into the restricted passages to effect driving of the hub 30 as soon as the crank handle 14 is cranked clockwise for driving the hub 30.

When it is required for the hub 30 to be driven anticlockwise, for example when a nut or bolt is to be loosened, the thumb knob 72 is pushed anticlockwise or to the right (FIG. 19). The finger 74 of the switch 72 shifts or slides the block 54 in the anticlockwise direction until the detent recess 78 registers with the detent ball or stub 86, which keeps the switch 72 and hence the block 54 in position relative to the cup 32. That causes the right-hand spring 60 to push against the roller bearing member 82.1. As before, since the roller bearings and the transfer devices are contiguous, the entire single file of bearing members and transfer devices are shifted anticlockwise. Particularly, the roller bearings 82.1 to 82.4 are shifted into an anticlockwise locking position in which the roller bearings 82 are urged to settle towards the restricted distal end of the passage 56.2. At the same time, the roller bearings 84 are also urged towards the restricted left-hand end of the passage 56.3.

In this configuration, as can be seen in FIG. 19, contact points 122 can be seen in gang 82 and bearings 84.1 to 84.3. At these points, there is frictional engagement between the bearings 82, 84.1 to 84.3, the hub 30 and the cup 32. Also, gaps or spaces 124 can be seen between the bearings 80.2 to 80.4 and 84.4, 84.5 and the cup 32. The roller bearing 80.1 is seated in the proximal end portion 61.2 of the passage 56.1. In that position, the roller bearing 80.1 acts as a conventional roller bearing accommodating freewheeling rotation of the cup 32 in a clockwise direction.

In doing so, the geometry of the mechanism is not compromised since roller bearings 82.1 to 82.4, 84.1 and 84.2 virtually “float” while roller bearings 82.1, 84.3 and 80.1 act as conventional roller bearings to stabilise movement and provide smooth rotation.

The profile of the outer surface 59 in relation to the bearings and the inner surface 57 is such that the bearings 82.1 to 82.4 and 84.1 to 84.3 are received in the passages 56 in a manner that inhibits any further displacement of the bearings in the anticlockwise direction along the passages. It follows that the hub 30 and the cup 32 are effectively locked together in the sense that when the crank handle 14 is rotated anticlockwise in a loosening direction, no relative movement of the cup 32 and the hub 30 is possible, resulting in the hub 30 being driven by the cup 32 via the frictionally engaged bearings. Thus, the frictionally engaged bearings are in a loosening condition to allow loosening of a right-hand threaded fastener. Geometries of the passages are described above with reference to the involute curves defined by the inner bearing surface 59 defined by the cup 32.

When, however, the crank handle 14 is rotated in the clockwise direction, bearings 84.1 to 84.3 and 82.1 to 82.4 are disturbed or unsettled by relative movement of the cup 32 and the hub 30. The profile of the surface 59 in relation to the bearings 84.1 to 84.3 and 82.1 to 82.4 and the surface 57 of the hub 30 are such that the bearings are unsettled sufficiently within a relative small angular displacement of the crank handle, for example from 0.1 to 0.5 degrees, sufficiently to enable rolling of bearings 80.1 and 84.3 in a conventional manner under influence of the relative rotation of the cup 32 and the hub 30.

During this clockwise movement, the springs 58 and 60, the motion transfer devices 48, and the block 54, which is retained in position by operation of the recess 78, the ball 86 and the spring 88, serve to bias bearings 82.1 to 82.4 and 84.1 to 84.3 towards the restricted passages, albeit in an unsettled condition. That results in the bearings 80.1 and 84.3 being capable of rotation, in conventional roller bearing fashion such that substantially drag-free rotation of the crank handle in a clockwise direction can occur relative to the hub 30.

Upon ceasing of the free-wheeling clockwise rotation, the springs 58 and 60 and the motion transfer devices 48 immediately reset bearings 84.1 to 84.4 and 82.1 to 82.3 into their settled locked condition into the restricted passages to effect driving of the hub 30 as soon as the crank handle 14 is cranked anticlockwise for driving the hub 30. This can happen from 0.1 and 0.5 degrees to practically an infinite number of locking positions.

As described above, the roller bearings have varying diameters, from a largest to smallest, thus, progressively smaller diameters with the smallest roller bearing being positioned closest to an associated restricted end(s) of the passage provided as a result of the involute profiles referred to above. As result, those bearings that lock up may lock in what is an effectively immediate sequence from the smallest roller bearing to the largest roller bearing. Because these bearings effectively locate in races that are dimensioned to accommodate the respectively decreasing diameters, they lock together to transmit torque to the driven hub as the crank handle 14 is rotated. This feature allows transmission of torque from the handle to the cup and then to the driven shaft without undue stress concentrations.

The roller bearings that act as conventional roller bearings accommodating freewheeling rotation can provide a smooth, drag-free perception during operation while retaining the locking bearings in the restricted ends of the passages to provide a perception of instantaneous engagement during transition from free-wheeling to driving, either clockwise or anticlockwise, within 0.1 to 0.5 degrees arc swing movement.

The degrees a ratchet spanner or wrench may be rotated backwards or in a return or reverse direction before re-engagement is known as “arc swing”. One problem with all ratchet spanners is the finite number of increments the spanner may be rotated backwards as ratchet wrenches or spanners have a finite number of engagement points and are therefore limited to the degree of backward rotation by the number of teeth. For example, if there are 72 teeth, the ratchet spanner is limited to 5° increments (72 divided into 360° equals 5° increments) when rotating backwards before another tooth can be engaged. If the head of the bolt is located in a limited space, it may be impossible to rotate the ratchet spanner a full 5°. This would render the ratchet wrench unworkable.

Because the bearings (see FIGS. 16) 80.1, 80.2, 80.3, 80.4 and 82.4 and 82.5 are positioned and held in the restricted end portions of their passages, they can provide a perception of immediate locking because there is practically or perceptibly an infinite number of locking positions compared to the 72 locking positions of the 72 tooth ratchet mechanism. This is useful in those cases where a long handle is used for difficult to reach areas, such as are often encountered in aviation or aeronautical engineering. As mentioned above, use of a long handle is feasible due to the small return arc swing required to drive the hub 30.

The torque transmission assembly 16, for example as represented in FIGS. 14 and 18, can be pressed into the carrier 18, as described above. It follows that the carrier 18 is not required to act on any particular point when the crank handle 14 is manipulated. For example, and as can be seen in the drawings, the torque transmission assembly 16 has a non-circular plan profile. This serves to help lock the assembly 16 against rotational movement relative to the crank handle 14.

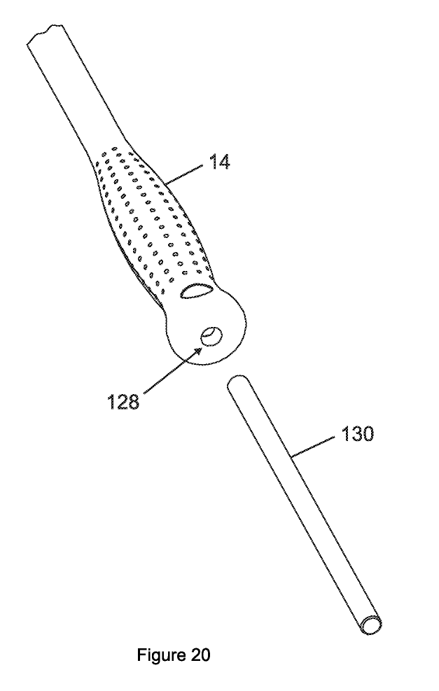

As a result of this, the crank handle 14 and the carrier 18 can be of a lightweight metal, such as an aluminium alloy. An example of such a handle is shown in FIG. 20. Where an aluminium alloy is used, operators can handle the wrench 10 for a significantly longer period of time without fatigue than in those cases where steel is used for the handle. This is particularly useful where operators are required to spend long periods of time in the field and are required to carry tools with them. One example of such a situation is where operators are required to carry out maintenance or installation in elevated positions, such as on towers.

A passage 128 may be drilled longitudinally into the handle 14 to increase the strength of the handle (FIG. 20), by generating internal load bearing surfaces set up by bending moments during operation of the wrench. A length 130 of suitable material, such as spring steel, can be inserted into the handle 14 via the passage 128 extending into the handle 14.

The aluminium alloy can be anodised to inhibit a chemical reaction or corrosion which may result at the junction of the steel carrier 18 and the head 12. Furthermore, the anodising of the aluminium alloy can be carried out to provide the aluminium alloy with an aesthetically pleasing colour. The inventor believes that an aluminium alloy with a colour may be aesthetically pleasing and a point of distinction.

The anodising layer can also be selected to enhance the strength of the material. For example, certain anodising colours can increase the hardness (up to 80 Rockwells) and structural integrity of the aluminium. In addition, the anodising layer can provide a level of electrical non-conductivity. This may be up to 10 000 volts.

It is to be noted that the handle is machined and not cast in order to retain the mechanical properties of the aluminium alloy.

Compared to conventional ratchet wrenches, the use of the aluminium alloy can result in a 50% or more weight reduction for the same size ratchet wrench socket drive.

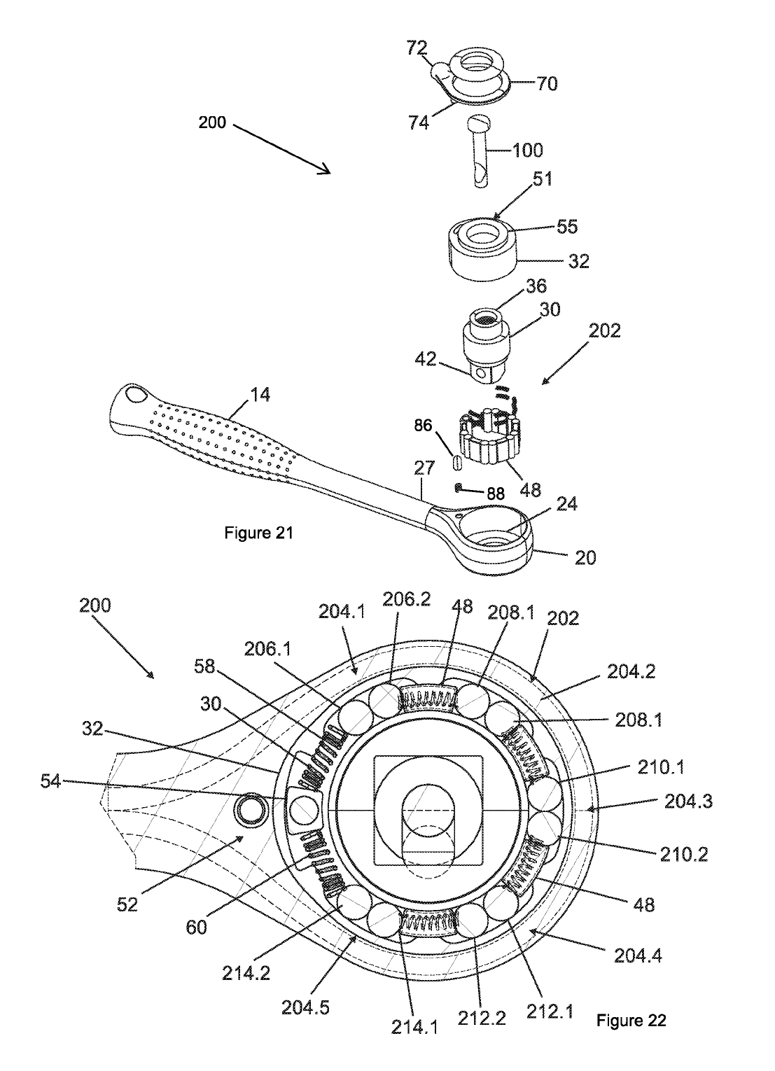

In FIGS. 21 and 22, reference numeral 200 generally indicates another embodiment of a wrench. With reference to the preceding drawings, like reference numerals refer to like parts, unless otherwise specified. The use of common reference numerals is not intended to limit the scope of the appended claims and is for the purpose of convenience only. Furthermore, components or characteristics of the wrench 10 are interchangeable with components or characteristics of the wrench 200, if possible and/or practicable.

The wrench 200, although not identical to the wrench 10, is similar in construction. However, a torque transmission assembly 202 is somewhat different to the assembly 16.

In this embodiment, the assembly 202 includes five passages 204.1, 204.2, 204.3, 204.4 and 204.5 counted in a clockwise, tightening direction. Two roller bearings 206, 208, 210, 212, 214, referenced with 0.1 and 0.2 in a tightening direction, are located in each passage 204.

The roller bearings 206 to 214 have substantially the same dimensions. For example, as will be seen later, the roller bearings 206 to 214 can have a diameter of 4 mm in one application. It is envisaged that the roller bearings 206 to 214 can have any of the dimensions set out in this specification with reference to the other embodiments.

Ends of each passage 204 are restricted. In this case, the ends are substantially the same. It follows that either of the bearings in each passage can lock up while the other can act as a conventional roller bearing depending on the direction in which the switch 72 is driven. In FIG. 22, the switch 72 is in a neutral position, where it can be seen that neither of the bearings is in a locked up or driving configuration.

The motion transfer devices 48 are located between respective pairs of bearings 202 to 214 to convey shifting or movement from one pair to the other.

The selector mechanism 52 and the springs 58, 60 serve, as before, to maintain a contiguous relationship between the bearings and the motion transfer devices.

The selector mechanism 52 operates in a similar fashion as it does in the wrench 10. In other words, a clockwise shift results in the bearings 206.2, 208.2, 210.2, 212.2 and 214.2 causing lock-up of the cup 32 and the hub 30 in a tightening direction. When the wrench 200 is cranked anti-clockwise, those bearings are unsettled by relative movement of the cup 32 and the hub 30. This allows an anticlockwise free-wheeling movement against a bias of the spring 58. As that movement is stopped, the spring 58 serves immediately to lock up those bearings.

An anticlockwise shift results in the bearings 216.1, 214.1, 212.1, 210.1 and 208.1 causing lock up of the cup 32 and the hub 30 in a loosening direction. When the wrench 200 is rotated clockwise, the free-wheeling movement is again set up and lock up occurs as a result of the bias of the spring 60 as soon as that rotation is stopped.

In this embodiment, there is shown five passages 204. However, in some cases, the hub 30 may be enlarged and may define an internal passage for receiving a shank of a fastener. This would allow the wrench 200 to be positioned with the shank extending from a proximal side of the wrench 200, allowing the wrench 200 to engage a nut on the shank. For such use, the torque transmission assembly 202 can have any number of further passages 204. In such an embodiment, use of the selector and the motion transfer devices allows the roller bearings to be switched between the tightening and loosening conditions without the need for lifting the wrench off the shank.

Generally, and with reference to the various embodiments herein, it is envisaged that with further passages, the wrench can be enlarged to any extent so that the hub can be provided with an opening for receiving part of a structural element, such as a shank. In cases where the shank is unconventionally large, the wrench can be provided with an appropriate number of passages to accommodate an enlarged bore through the hub 30. It will be appreciated that, in such embodiments, the bore of the hub can be provided with fast engaging formations such as conventional flats or other formations used to engage fasteners. Thus, engagement would take place with the fasteners within the hub 30.

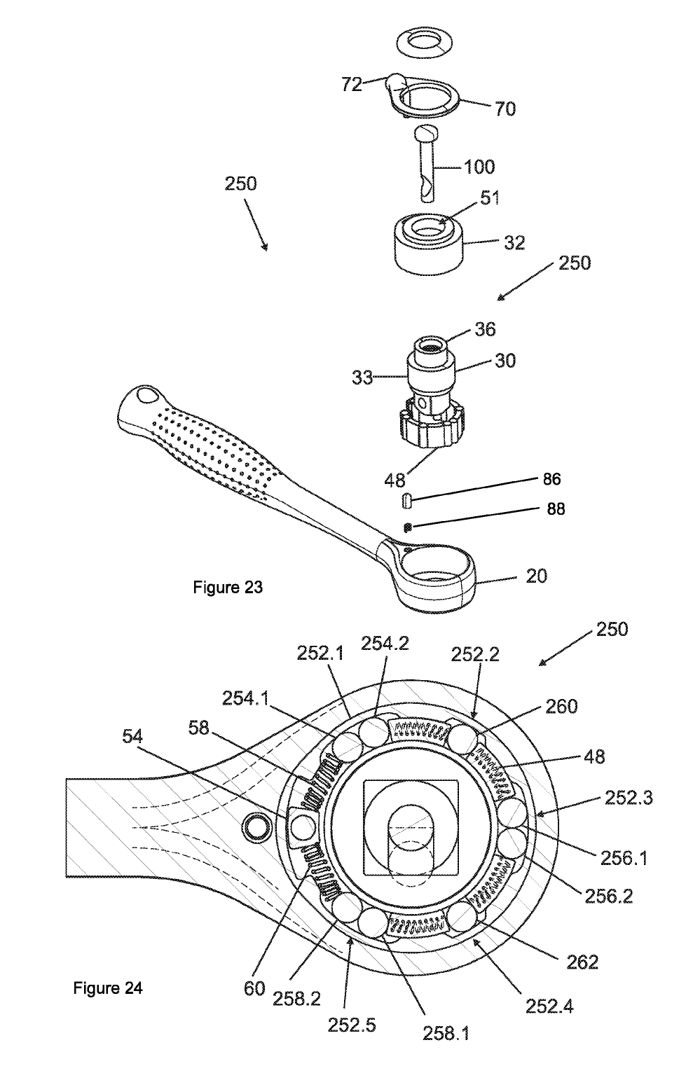

In FIGS. 23 and 24, reference numeral 250 generally indicates another embodiment of a wrench. With reference to the preceding drawings, like reference numerals refer to like parts, unless otherwise specified. The use of common reference numerals is not intended to limit the scope of the appended claims and is for the purpose of convenience only. Furthermore, components or characteristics of the wrench 10, 200 are interchangeable with components or characteristics of the wrench 250, if possible and/or practical.

As with the wrench 200, there are five passages, 252.1 to 252.5, counted clockwise, in a tightening direction. However, for the reasons described with reference to the wrench 200, further passages 252 can be provided depending on the required diameter of the hub 30 to suit a structural or mechanical component such as a shank, with the hub 30 defining a bore to accommodate the component.

Two roller bearings 254.1, 254.2 are positioned in the passage 252.1, two roller bearings 256.1, 256.2 are positioned in the passage 252.3 and two roller bearings 258.1, 258.2 are positioned in the passage 252.5. A single roller bearing 260, 262 is positioned in each of the passages 252.2, 252.4.

The passages 252.1, 252.3 and 252.5, which accommodate the pairs of roller bearings are positioned substantially at the vertices of an equilateral triangle. This provides a desirable stress distribution through the head 12 during tightening or loosening operations.

The passages 252 are similar to the passages 204 of the wrench 200, with the passages 252.2, 252.4 accommodating the single bearings 260, 262 being circumferentially shorter than the other passages so that the single rollers 260, 262 can move in or out of the locking conditions.

The wrench 250 operates in a similar fashion to the wrench 200. The difference is with the bearings 260, 262 that are capable of movement from one end to the other end of their respective passages.

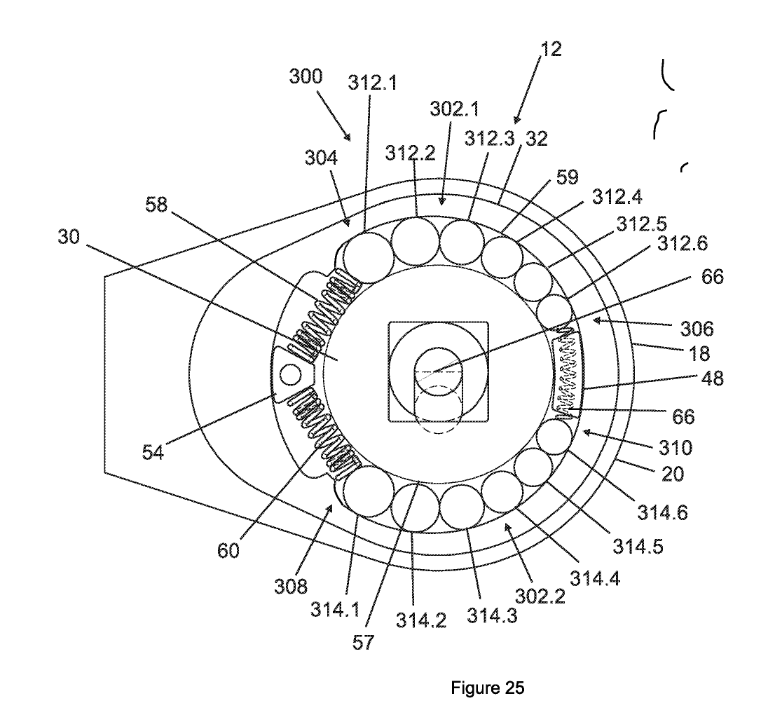

In FIG. 25, reference numeral 300 generally indicates another embodiment of a wrench. With reference to the preceding drawings, like reference numerals refer to like parts, unless otherwise specified. The use of common reference numerals is not intended to limit the scope of the appended claims and is for the purpose of convenience only. Furthermore, components or characteristics of the wrench 10, 200, 250 are interchangeable with components or characteristics of the wrench 300, if possible and/or practical.

The wrench 300 has a torque transmission assembly 301 that has two passages 302.1, 302.2. The passages 302.1 and 302.2 are symmetrically positioned about a diametrical axis relative to each other. In the passage 302.1, the radial profile of the cup bearing surface 59 of the cup wall 46 defines an involute, as with the previous embodiments, with a decreasing radius from a proximal end portion 304 to a distal end portion 306, with reference to the centrepoint 66 of the hub 30. In the passage 302.2, the radial profile of the cup bearing surface 59 of the cup wall 46 also defines an involute, which is a mirror image of the involute of the passage 302.1, with a decreasing radius from a proximal end portion 308 to a distal end portion 310.

As with the previous embodiments, the resultant restrictions in the passages 302.1 and 302.2 can be achieved in other ways, for example, by the outer surface 57 of the hub 30 having an appropriate profile, such as the involutes described above.

There are six roller bearings 312.1 to 312.6 positioned in the passage 302.1 and six roller bearings 314.1 to 314.6 positioned in the passage 302.2. The roller bearings 312 decrease consecutively in diameter from the roller bearing 312.1 at the proximal end portion 304 to the roller bearing 312.6 at the distal end portion 306. Likewise, the roller bearings 314 decrease consecutively in diameter from roller bearing 314.1 at the proximal end portion 308 to the roller bearing 314.6 at the distal end portion 310.

The roller bearings 312 and 314 can have the following diameters:

a. Roller bearings 312.1 and 314.1: 4.927 mm.

b. Roller bearings 312.2 and 314.2: 4.680 mm.

c. Roller bearings 312.3 and 314.3: 4.336 mm.

d. Roller bearings 312.4 and 314.4: 4.020 mm.

e. Roller bearings 312.5 and 314.5: 3.705 mm.

f. Roller bearings 312.6 and 314.6: 3.449 mm.

The relative dimensions of the roller bearings 312 and 314 and the bearing surfaces 57 and 59 in the passages 302.1 and 302.2 are such that the roller bearings 312 and 314 can shift together towards the distal ends 306 and 310, respectively, into a position in which the roller bearings 312 and 314 nest in the passages 302.1 and 302.2, respectively, with contact points being defined between the roller bearings 312 and 314, themselves, and between the roller bearings 312 and 314 and both the bearing surfaces 57 and 59. Furthermore, the relative dimensions are such that, when the roller bearings 312 and 314 are in that nested condition, frictional engagement is set up substantially equally across the contact points and between the roller bearings, such that the roller bearings can be shifted between tightening and loosening conditions.

The roller bearings can each have a length of between about 10 mm and 14 mm, for example, 11.8 mm.

In this embodiment, a single motion transfer gap 38 is interposed between the passages 302.1 and 302.2. One motion transfer device 48 is thus positioned in the gap 38 to transfer movement of the roller bearings 312 to the roller bearings 314, and vice versa. As before, this is achieved by operation of the selector device 52.

The wrench 300 operates in the same manner as the wrenches 10, 200, 250. Thus, when the switch 72 is urged clockwise, the roller bearings 312 are urged towards the restricted distal end 306 and engage other frictionally to lock the cup 32 relative to the hub 30 so that clockwise or tightening rotation of the crank handle 14 results in clockwise rotation of the hub 30. As before, when the crank handle 14 is rotated in an anticlockwise direction, the roller bearings 312 are unsettled and the cup 32 is able to rotate freely with respect to the hub 30 in an anticlockwise direction. The cup surface 59 of the cup wall 46 is profiled at the proximal end portions 304, 308 so that the roller bearings 312.1 and 314.1 can rotate, in the manner of a conventional roller bearing, within the end portions 304, 308, respectively. In the condition described above, the roller bearing 314.1 rotates freely in the proximal end portion 308 as the crank handle 14 is turned or rotated anticlockwise, in an opposite or resetting direction. As before, as soon as the crank handle 14 is stopped, the spring 58 ensures that the bearings 312 settle into the locked condition to allow further tightening.

Similarly, the switch 72 can be urged anticlockwise to lock the bearings 314 relative to each other, the cup wall 46 and the hub 30 to permit the hub 30 to be driven in a loosening direction. Rotation or turning of the crank handle 14 in a clockwise direction results in the roller bearings 314 becoming unsettled such that the cup 32 is able to rotate freely with respect to the hub 30 in an opposite or resetting clockwise direction. In that condition, the roller bearing 312.1 rotates freely in the proximal end portion 304. As soon as the crank handle 14 is stopped, the spring 60 ensures that the bearings 314 settle into the locked condition to allow further loosening.

The inventor(s) submits that the torque transmission assemblies described above deliver an arc swing of 0.1 to 0.5 degrees. Furthermore, the action of the roller bearings during opposite or reverse rotation provides near zero drag factor to an operator.

This is useful when using the various exemplary embodiments of the wrench in those areas where arc swing is limited. In addition, it allows for the use of long handles to achieve high torque and to reach difficult areas.

The roller bearings of the various embodiments described above can be of a range of suitable dimensions provided that the variation between the consecutive roller bearings in each passage is consistent to facilitate or encourage sequential locking of the roller bearings in a substantially instantaneous manner.

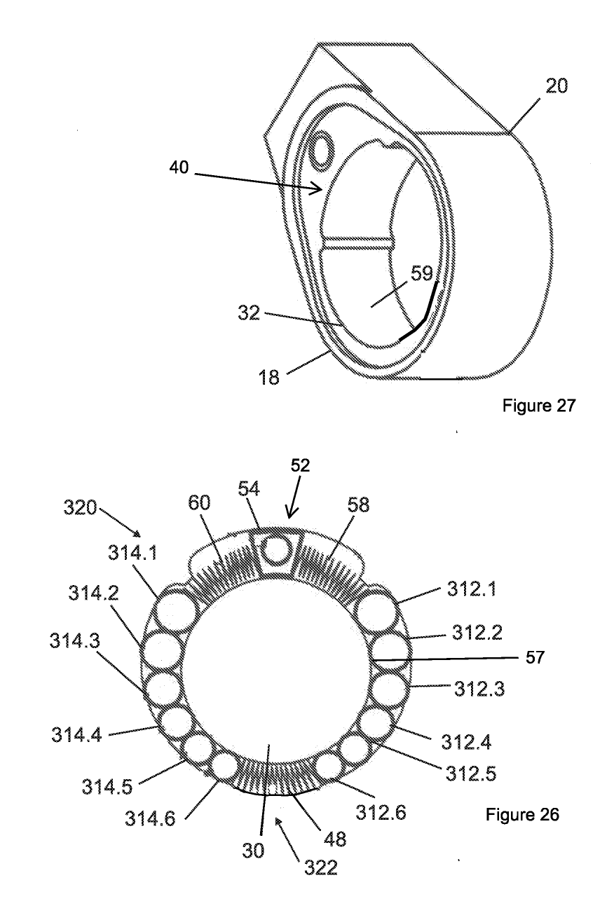

In FIG. 26, reference numeral 320 generally indicates a schematic plan view of a torque transmission assembly showing the bearing surface 59, the bearing surface 57, the motion transfer device 48, the selector 52 and the bearings 312 and 314. The rest of the torque transmission assembly 320 is not shown, for purposes of clarity and ease of description. With reference to the preceding drawings, like reference numerals refer to like parts, unless otherwise specified. The use of common reference numerals is not intended to limit the scope of the appended claims and is for the purpose of convenience only. Furthermore, components shown in FIG. 26 and related figures are interchangeable with the components described with reference to the previous embodiments, if possible and/or practical.

The torque transmission assembly 320 is similar to the torque transmission assembly 310.

FIG. 27 shows a three-dimensional view of the cup 32 of the torque transmission assembly 320 fitted into the carrier 18 showing the cup surface 59.

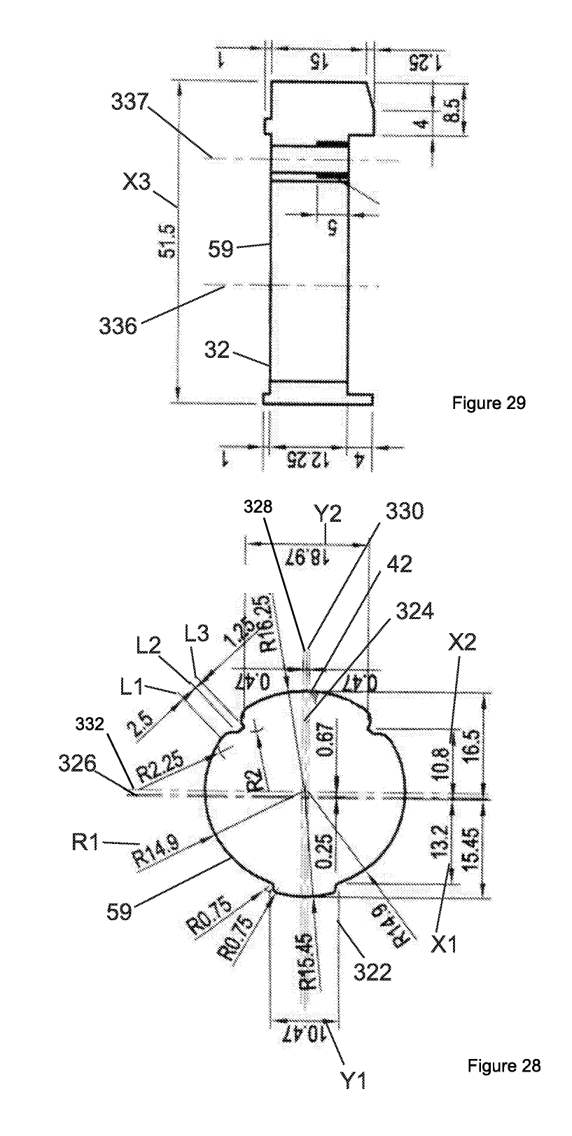

In FIG. 28, there is shown, in a plan view, the surface 59, in order to illustrate an example of suitable dimensions, and how they are achieved, for the cup surface 59. In this drawing, reference is made to a first x-axis 324, which bisects the cup or bearing surface 59, through the selector space 42 to define an axis of symmetry. A first y-axis 326 intersects the first x-axis 324 to define an x-y plane. A second x-axis 328 is positively offset from the first x-axis 324 and a third x-axis 330 is negatively offset from the first x-axis 324. A distance between the first and third axes 328 and 330 is about 0.47 mm. A second y-axis 332 is positively offset from the first y-axis 326. The distance between the first and second y-axes 332 and 326 is about 0.67 mm. A third axis (not visible in the drawing) is offset negatively by about 0.25 mm from the first-axis 326.

FIG. 29 shows a schematic, inner side view of the cup 32 that defines the surface 59.

In FIGS. 28 and 29, the dimensions shown are expressly intended to form part of this disclosure and have been shown on the drawings for convenience and ease of understanding. However, it is envisaged that other dimensions can be used. For example, where the hub 30 is required to be of a sufficient diameter to permit a passage to be defined through the hub 30, for the purposes of receiving an elongate member, such as a shank, to permit the various embodiments of the wrench to achieve access to a fastener, the dimensions could be adjusted upwardly, to an appropriate extent.

As referred to above, the cup bearing surface 59, in each passage for the bearings 312 and 314, has a profile or is radiused to correspond with the size of the bearings 312, 314. It will be appreciated that, with a known diameter of the hub 30, the profile can be determined by plotting out the required contact points to achieve the necessary curve. With reference to one half of the cup 32, on a positive side of the first x-axis 324, a radius R1 of the cup bearing surface 59 is about 14.9 mm from the recess 322, or an edge of the profile on a negative side of the primary y-axis 326, to a line L1 on a positive side of the y-axis 326. The radius R1 of the profile on the positive side of the first x-axis 324 is measured from an intersection of the second x-axis 328 and the second y-axis 332. Similarly, the radius R1 of the profile on the negative side of the first x-axis 324 is measured from an intersection of the third x-axis 330 and the second y-axis 332. A radius of about 2.25 mm is applied to the profile at the line L1 to a further line L2 spaced about 2.5 mm from the line L1. This allows the seating of the bearings 312.1 and 314.1, in the manner described above, to achieve the necessary “freewheeling” effect.

A distance X1 between the primary y-axis 326 and a start of the profile on the negative side of the axis 326 is greater than a distance X2 between the primary y-axis and an end of the profile with the radius R1.

Furthermore, the hub 30, and thus the outer bearing surface 57, has a diameter of about 21.68 mm. The hub 30 is mounted in the cup 32 so that the bearings 312 to 314 can be positioned in the passages 302, in the manner described with reference to FIG. 26. This results in a position of the centrepoint 66 such that the profile of the bearing surface 59, as described above, defines the involute with reference to the bearing surface 57 and the centrepoint 66. In other words, it is a combination of the dimensions of the hub 30 and the roller bearings 312 to 314 that provides the involute profile of the passages 302. That said, the dimensions shown in FIGS. 28 to 29 are with reference to fixed, rather than variable radii, so that fabrication of the cup 32 can take place without reference to the hub 30. It will be appreciated that the necessary offset of the centrepoint 66 with reference to the points of reference for the radius R1 provides the involute surfaces.

It is also to be understood that the principles described above with reference to FIG. 28 are equally applicable to the torque transmission assemblies of the other exemplary embodiments of the wrench described in this specification that use involute surfaces.

Thus, it is to be understood that similar principles can be used to fabricate the other embodiments that use varying sizes of roller bearings in the respective passages. That is, generating a profile from a centrepoint that is offset from the centrepoint 66 to a point at which it is required to radius the bearing surface 59 to provide the necessary seating of the larger bearings.

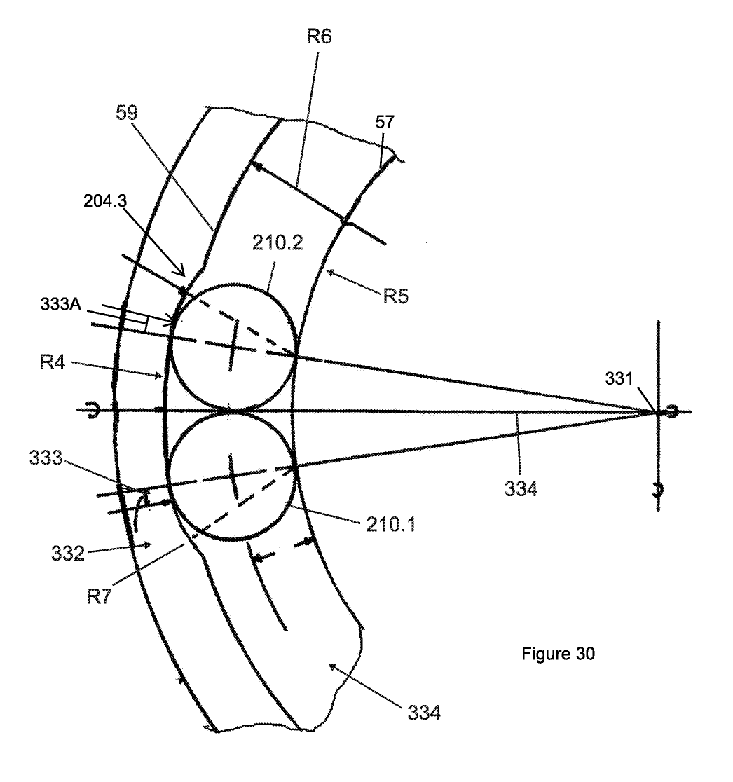

In FIG. 30, there is shown a schematic view of various dimensions that could be used in the fabrication of the wrenches 200, 250. With reference to the preceding drawings, like reference numerals refer to like parts, unless otherwise specified. The use of common reference numerals is not intended to limit the scope of the appended claims and is for the purpose of convenience only. Furthermore, components or characteristics shown in FIG. 30 are interchangeable with components or characteristics of the various embodiments described in the specification.

The cup surface 59 defining the passage 204.3 has a radius R4 of about 15.5 mm, measured from a centrepoint 331. The outer bearing surface 57 defining the passage 204.3 has a radius R5 of about 11.45 mm. The cup bearing surface 59, intermediate the passages 204, has a radius R6 of about 15.0 mm. A transition zone 332 of the cup bearing surface 59, between the passage 204.3 and a radially narrowed portion 334 between the hub 30 and the cup 32, has a radius R7 of about 4.0 mm.

The bearings 210.1 and 210.2 each have a diameter of about 4.0 mm. In this embodiment, the bearings 210 are shown side-by-side, and in contact on a centreline 334 that extends through the centrepoint 331.

This configuration allows an arc length of movement of about 0.5 mm, indicated at 333 and 333A, on either side of the centreline 334, before the bearings 210 become frictionally engaged with each other and the bearing surfaces 57, 59. It follows that, with the selection of a suitable radius R7 with respect to a diameter of the bearings 210, it is possible to predetermine an extent of movement required for locking of the bearings 210 to the surfaces 59, 57. In this case, that extent of movement, between the tightening and the loosening conditions will be about 1 mm. The inventor(s) submits that the various dimensions provided can be adjusted to achieve different extents of such movement, if necessary.

In the specification, including the claims, use of “tightening” is with reference to a right-hand thread. In other words, for clockwise driving of a nut or bolt when viewed proximally.

The inventor(s) envisages that the torque transmission assemblies described herein can find other applications where a reversible, ratchetless drive is required. It follows that the exemplary embodiments extend to the torque transmission assemblies described herein. It is envisaged that many other reversible ratchetless drives are applicable throughout industry. It follows that the inventor envisages that such ratchetless drives could incorporate any of the exemplary embodiments of the torque transmission assemblies described herein.

The exemplary embodiments also extend to a wrench that includes a handle and a carrier of aluminium with specific MPa specifications. The handle and carrier are not restricted to aluminium or steel, provide the MPa specifications are met. For example, the handle and the carrier could be of a reinforced plastics material or any other non-metallic material with suitable strength specifications.

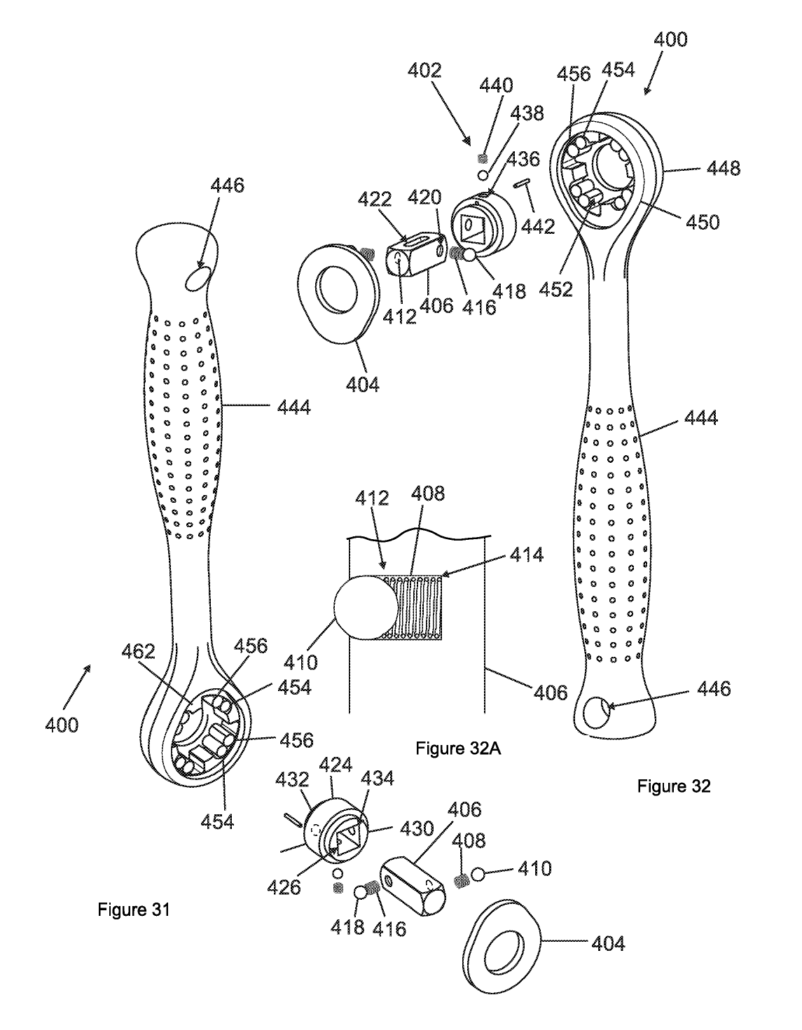

In FIGS. 31 and 32, reference numeral 400 generally indicates a further embodiment of a wrench. With reference to the preceding drawings, like reference numerals refer to like parts, unless otherwise specified. The use of common reference numerals is not intended to limit the scope of the appended claims and is for the purpose of convenience only. Furthermore, components or characteristics of the wrench 10, 200, 250, 300, and various other components described above, are interchangeable with components or characteristics of the wrench 400, if possible and/or practical.

The wrench 400 has a drive mechanism or torque transmission assembly 402. The assembly 402 has a cover plate 404, a drive member 406, a spring 408, a ball 410 and a blind hole 412 in which the ball 410 and the spring 408 are permanently retained by an open end which is smaller than a bore 414 of the hole 412 as shown in FIG. 32A.

In a similar manner, a spring 416 and a ball 418 are retained in a blind hole 420. The drive member 406 also has a groove 422.

The torque transmission mechanism 402 also has an inner body in the form of an inner runner 424 which has a square hole 426. The inner runner 424 has a round body 428 having end flanges 430 and 432 of lesser diameter that the body 428.

A recess or detent 434, as well as a hole 436, retains a ball 438, a spring 440 and a locking pin 442. When assembled, the drive member 406 extends into the square hole 426 and is retained by the ball 438 and the spring 440, which are accommodated in the groove 422 and held therein by the locking pin 442.

There is also provided a handle 444, which has a retaining aperture 446, so that the wrench 400 can be hung on a hook (not shown) when not in use. The wrench 400 also has a head 448 having a circumferential body 450, which encloses a hollow interior 452, which retains four sets of one smaller diameter roller bearing 39 and one larger diameter roller bearing 456. Each set of roller bearings 454, 456 are retained in an associated passage or cavity 458. There is also shown a leaf spring 460 that is shown in greater detail in FIG. 45. The cavities 458 are separated by projections 462.

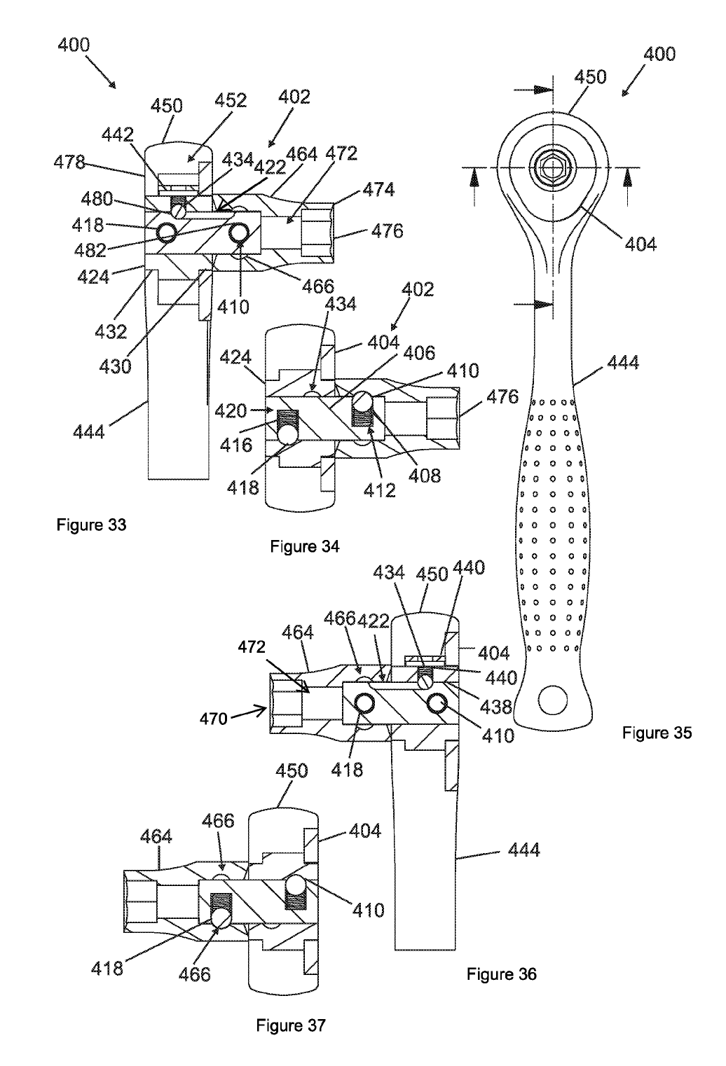

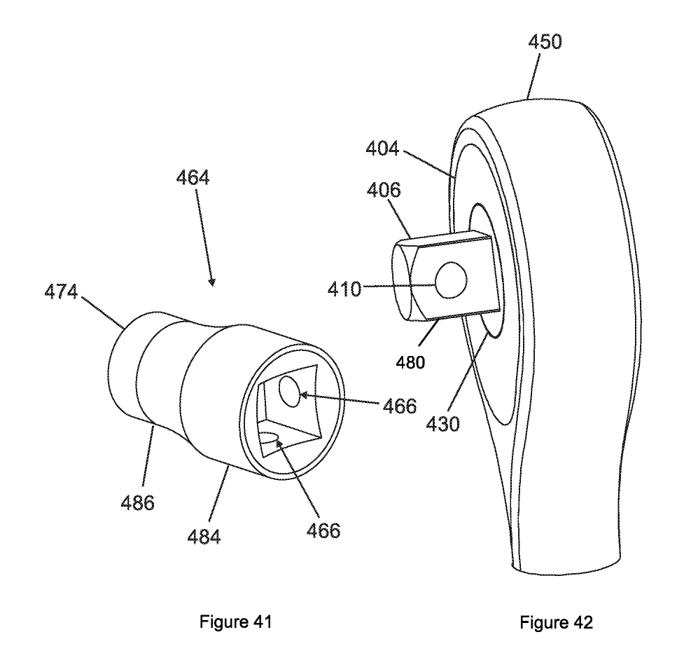

FIGS. 33 to 37 show an assembled view of the assembly 402 and also show an external socket 464, which engages with the drive member 406, as shown, which is held in place by the ball 410 or 418, depending on whether the drive configuration is clockwise or anti-clockwise. The external socket 464 also has detents 466 on each face 468 of an internal bore 470 shown in FIG. 41. The external socket 464 has a round internal bore 472 adjacent the internal bore 470, which is square in cross sectional shape. The external socket 464 also has a free end part 474 having serrations or ribs 476 to engage with an adjacent nut (not shown). There is also provided a retainer flange 478, which is integral with the body 450.

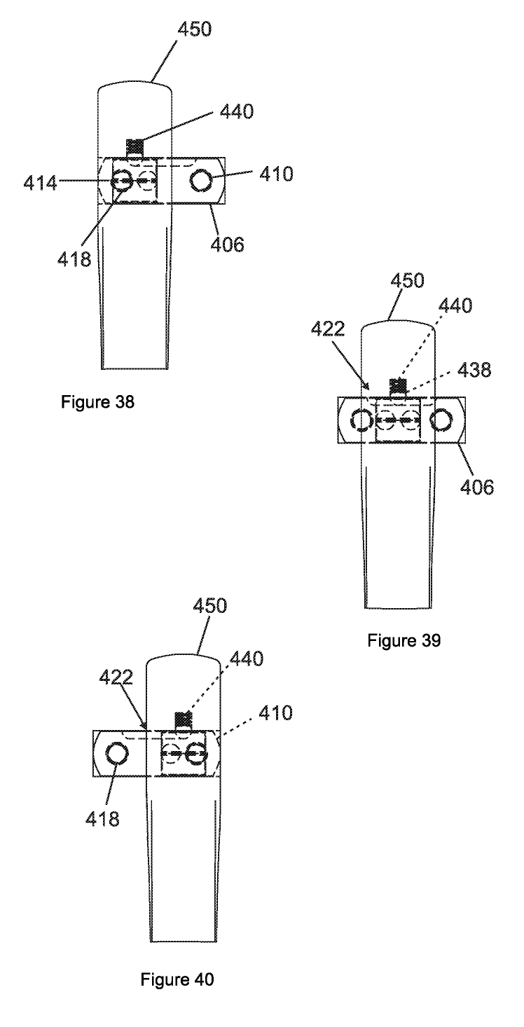

FIGS. 38 to 40 show movement of the drive member 406 relative to the circumferential body 450 during operation of the wrench 400. The drive member 406 may be moved manually from the position shown in FIG. 38, in which the ball 418 engages with the cavity or detent 414. This is the only means for retaining the drive member 406 within the inner runner 424. On movement of the drive member 406 through an intermediate position, as shown in FIG. 39, there is no retention of the drive member 406 within the inner runner 424 and such movement is facilitated by the ball 438, retained by the spring 440 in the detent 434 moving from one end of the groove 422, shown in FIG. 38, to another end of the groove 422, shown in FIG. 40. The combination of the ball 438, the spring 440 and the groove 422 is a guide mechanism for the drive member 406 as it moves relative to the inner runner 424.

On reaching the position shown in FIG. 40, the ball 410 engages with its associated detent 434 and the drive member 406 is held within the inner runner 424.

In the position shown in FIGS. 34 and 36, the ball 410 is retained within an associated detent 466 to retain the external socket 464 in engagement with the inner runner 424 and in the position shown in FIGS. 37 and 40, in which the ball 418 is in engagement with an adjacent detent 466 to retain the external socket 464 in engagement with the inward runner 424.

In FIGS. 36 and 37, the reverse movement is shown, in which the external socket 464 engages with the inner runner 424, the ball 418 engages with the detent 466 and the ball 410 engages with the associated detent 434.

The inner runner 424 locates within the hollow interior 452 of the head 448, with the end flange 432 locating in a position wherein the end flange 432 abuts the retainer flange 478 as shown in FIGS. 33 and 34. The reverse is shown in FIGS. 36 and 37, wherein the end flange 430 abuts the retainer flange 478 and the end flange 432 engages the cover plate 404.

In FIGS. 41 and 42 there is shown the external socket 464 having four of the detents 466 on the internal faces 468. The external socket 464 also has a round part 484 that defines the internal square bore 470 and an intermediate part 486, which has the internal bore 472. The internal square bore 470 is a female part, which engages with a male part 488 of the drive member 406.

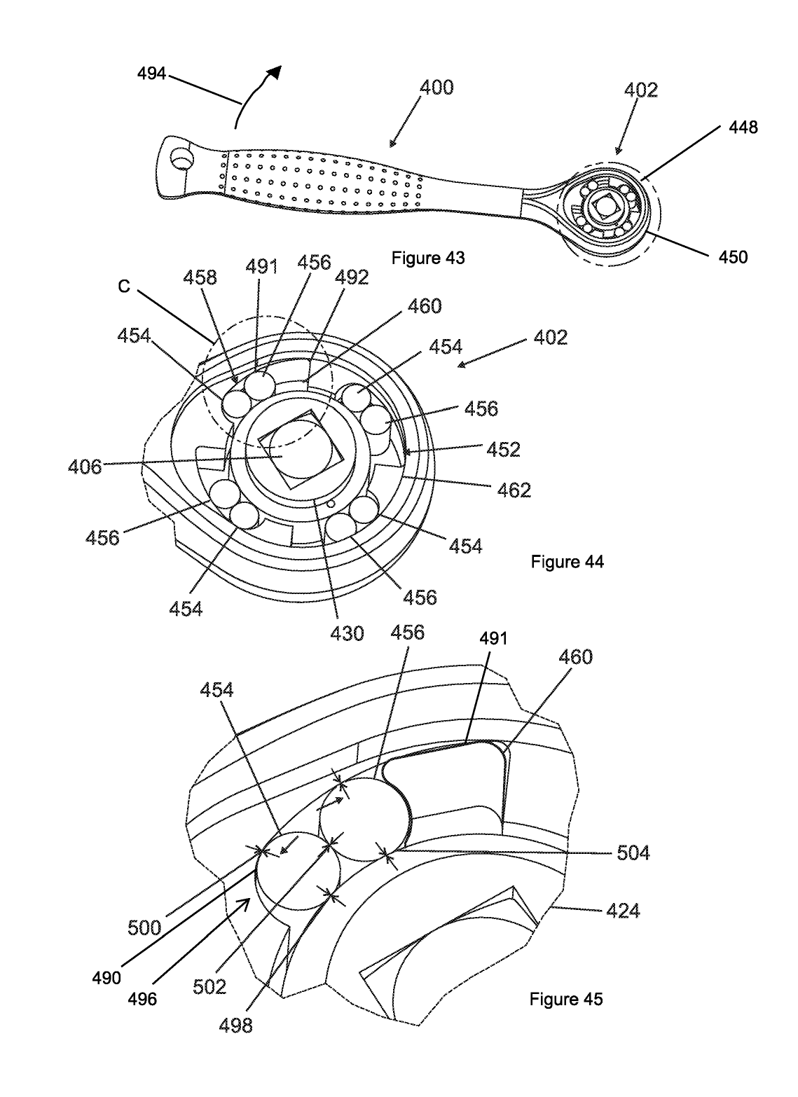

In the operation of the torque transmission assembly 402, as shown in FIGS. 43 to 45, there are four groups or sets of the roller bearings 454, 456, in the form of cylinder roller bearings, located riding in the passage, cavity or race 458 that is tapered or curved to abut both roller bearings 454 and roller bearings 456. The roller bearings 454 are of lesser diameter than the roller bearings 456. Thus, the race 458 has a smaller curvature at 490 when compared to a curvature at 491, which is involute, to lock the roller bearings 454 and the roller bearings 456, in a possible sequence of two stages, as understood by the inventor, when the torque transmission assembly 402 is in a locked or drive position. The leaf spring 460, which can act as a motion damper, is located between an end 492 of the race or cavity 458 and the roller bearing 456.

When the handle 444 is moved with the head 448 in a clockwise direction as shown by an arrow 494, the roller bearings 454, 456 are maintained in position in the race 458 due to a pressure from the leaf spring 460. An arc of movement of the head 448 is calculated at about 0.1° to 0.5° in the clockwise direction after which the drive member 406 is restricted from anticlockwise movement. In that condition, the roller bearings 454, 456 lock the head 448 with the drive member 406 in two stages. The first stage occurs when the roller bearings 454 lock in the cavity or race 458, wherein a restricted end 496 (FIG. 45), resulting from the involute curvature 491, prevents any further movement of the roller bearings 454, 456 locked between locking positions 498 and 500 (FIG. 45). The second stage occurs when the roller bearings 456 are locked in a position abutting respective roller bearings 454 and locked between locking positions 504, 506 in the race 458. Reference is made to “stages”. However, for practical purposes, the locking of the roller bearings 454, 456 can be instantaneous. Further movement of the handle simply results in an amplification of a wedge-like condition being set up between the roller bearings 454, 456, the body 428 and the head 448.

In relation to the roller bearings 454, 456, the roller bearing 454 has a smaller diameter than the roller bearing 456 and the engineering requirements to maximise the torque capacity delivered within a desired accuracy of movement of 0.1° to 0.5° maximises a locking surface area within a defined space. For this to be achieved, roller bearing diameter measurement variations are specific and should be within one-thousandth of a millimetre for all the embodiments described herein. This serves to ensure that, with a hardness of material referred to above, the roller bearings 454, 456 can nestle or settle into the locked configuration in such a way that a pressure at the locking positions is substantially evenly distributed across the locking positions. It is to be appreciated that, without such levels of accuracy in fabrication, one of the roller bearings 454, 456 could bear a significant proportion of the load resulting in a failure to lock securely.

The locking positions are shown in FIG. 45, wherein contact of the roller bearings 454 and 456 with a surface 508 of the inner runner 424 occurs at 498 and 505, and contact of the roller bearings 454 and 456 with the race 458 at 506 and 500. This means that there are five locking positions for each set of roller bearings 454 and 456.

These features allow transmission of torque from the handle 444 to the inner runner 424 and then to the drive member 406 without undue stress concentrations that are typically associated with angled shapes under load. In addition, using an involute to restrict each race 458, rather than notching each race 458, as occurs in a conventional Bendix drive clutch, and maintaining separate groups of sets of roller bearings 454 and 456 rather than having a non-uniform cross-section, as occurs in a conventional Sprag clutch, allows greater torque transmission per unit of volumetric measurement than would be the case for a conventional wrench, using, for example, a ratchet mechanism.

A length of a locking area on an outer surface of the race 458 is indicated by “x” in FIG. 45 and the length of the locking area on an internal surface of the inner runner 424 is shown by “y” in FIG. 45.

Each of the surface areas “x” and “y” can be calculated as a percentage of the surface area of the external or outer surface 508 of the inner runner 424.

Calculations of the locking surface area can be based on:

a. a length of the roller bearings 454, 456;

b. diameters of the roller bearings 454, 456;

c. a distance between the centres of the roller bearings 454, 456; and

d. a number of groups of roller bearings and a number of roller bearings in each group.

The number of groups of roller bearings and the number of roller bearings in each group can vary from the illustrated embodiments shown in FIGS. 34, 44 and 57, with FIG. 47 showing four groups of two roller bearings per group, and FIG. 57 showing five groups of three roller bearings per group.

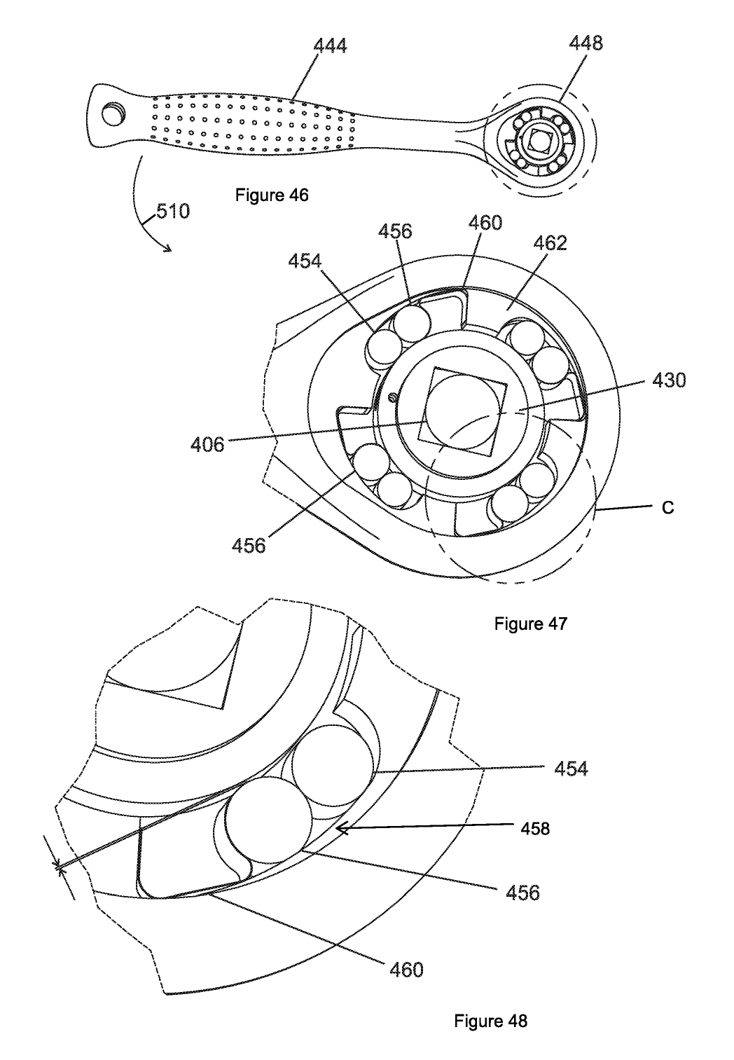

When the handle 444 is moved anti-clockwise, as shown in FIGS. 46 to 48, the spring 460 compensates for a pressure being exerted on the roller bearings 456, 454, in one set, and the roller bearings 454, 456, in another set, and the sets are moved from the locked positions shown in FIG. 48 to a position within the race or cavity 458 in which they perform as conventional roller bearings, substantially eliminating drag on the inner runner 424, and, in most instances, substantially inhibiting the runner 424 from turning anticlockwise at the same time as the handle 444 moves in the anti-clockwise direction.

More specifically, in FIGS. 46 to 48, as the handle 444 is turned anticlockwise as shown by arrow 510, the roller bearings 454 and 456 are released from the locked position as described above and adopt a “free-running” position, in which they function as conventional roller bearings for rotation of the inner runner 424. This means that the roller bearings 454 are released from the restricted race part at 490, and the roller bearings 40 are released from the locked position 502 as shown in FIG. 45 so that the roller bearings 454 and 456 are free to rotate.

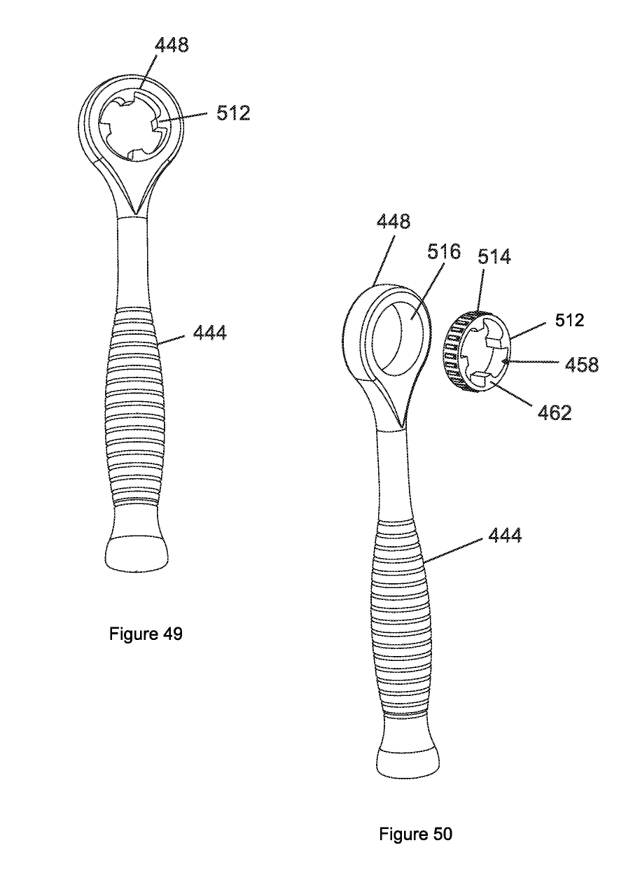

In FIGS. 49 and 50, reference is also made to another embodiment of a wrench in which, instead of the previous embodiment, wherein the rounded head 448 includes projections 462 and the races 458 are formed integrally within the rounded head 448, there is provided an insert 512, which includes the projections 462 and the races 458, as a component separate to the head 448. The insert 512 is provided with ribs 514 so that the insert 512 can be located within a hollow interior 516 of a head 518 of the wrench by interference fit, press fit or any other type of plug-socket interaction.

The adoption of a separate insert 512 helps to simplify manufacture. Thus, the insert 512 together with roller bearings 454 and 456, located together in an associated race 458, runner 424 and drive member 406 may be manufactured in one or more locations away from where the handle 444 and the head 448 are manufactured.

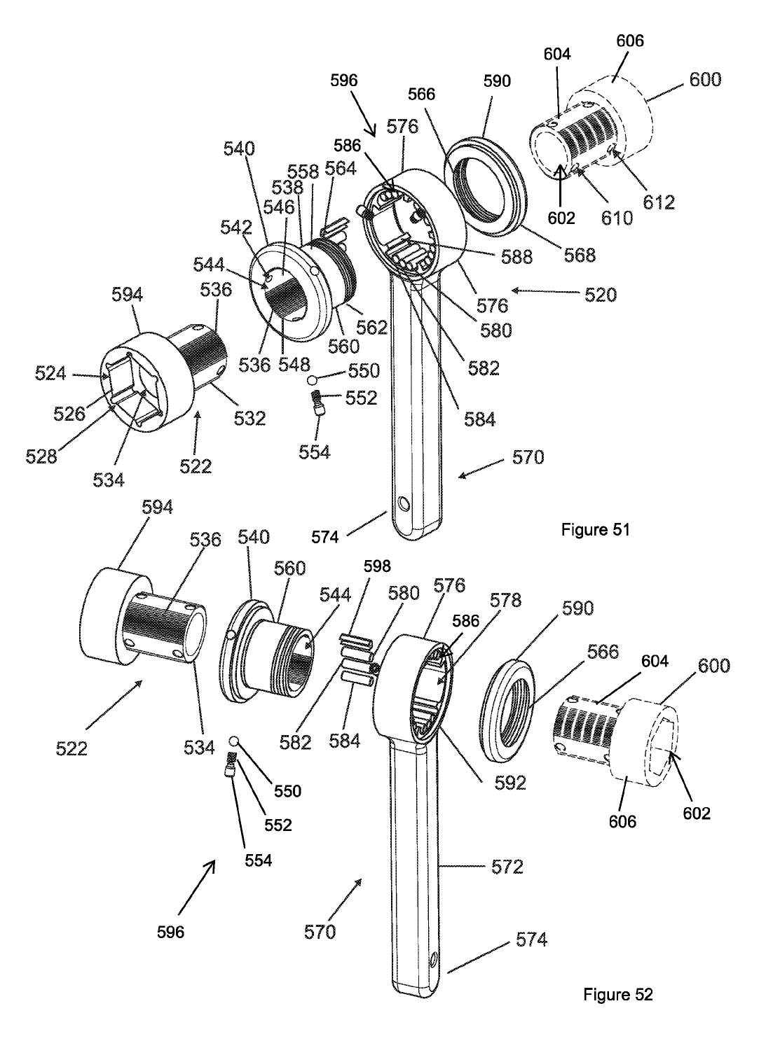

In FIGS. 51 and 52, there are shown alternative, exploded perspective views of a slogging spanner 520 which includes an outer socket 522 which has a hexagonally shaped cavity 524 having flat bearing faces 526 separated by an elongate recess 528. The provision of flat bearing faces 526 enables more contact or grip on a nut or bolt (not shown) and avoids marking of the nut or bolt. The outer socket 522 also has a head 594 and a cylindrical shank 532 having an internal bore 534 and serrations or grooves 536.

There is also provided an inner socket 538 having a head 540, threaded holes 542 and an internal bore 544 having an inner surface 546 with serrations or grooves 548 which engage the serrations 536. There are also provided balls 550, springs 552, and retaining screws 554, which each engage with an adjacent threaded hole 542.

An inner socket housing 558 also has a shank 560 having an unthreaded part 562 and an outer threaded part 564, which engages with a threaded interior 566 of a retaining member 568 when the slogging spanner 520 is fully assembled. A wrench or spanner 570 has a handle 572 and a retaining hole 574 for coupling with a hammer (not shown). The spanner 570 also has a head 576 with a hollow interior 578 which has sets of roller bearings 580, 582 and 584, each set retained in respective cavities or races 586 separated by projections 588. The retaining member 568 has a peripheral flange 590 which abuts a rim 592 of the head 576 when the slogging spanner 520 is fully assembled. The roller bearings 580, 582, and 584, together with the cavities or races 586 and the projections 588, form another example of a torque transmission assembly 596 and function in a similar manner as shown in the embodiments in FIGS. 43 to 48. Also provided are leaf springs 598 that operate in a similar manner to the leaf springs 460.

In FIGS. 51 and 52, there is also shown an alternative outer socket 600, which may be used instead of the outer socket 522. The outer socket 600 has a normal hexagonal aperture 602, with the elongate recesses 528 being omitted, and the shank 604. The outer socket 600 also has a head 606 and serrations or grooves 608.

The outer socket 600 also has threaded detents 610 and 612. It will be appreciated that the outer socket 522 or 600 may be used on either side of the assembly 596 as described in the previous embodiment. Thus, in FIGS. 51 and 52, balls 550 will engage with the detents 610 and 612 to retain the outer socket 522 engaged within the socket 538. However, if the outer socket 522 was used in the location shown by outer socket 600, the balls 550 will engage with the detents 610 and 612.

The mating grooves or serrations 536 (male) and 548 (female), or 608 (male) and 548 (female), are arranged in three spaced arrays as shown in the assembly 596.

In relation to a conventional slogging hammer, as shown for example at www.slogginghammer.com, the slogging spanner 520 is used instead of the conventional slogging spanner, which has an impact head at an opposite end of a spanner or wrench head. A hammer shaft of the conventional slogging hammer engages with an end 612 of the handle 570 which has an aperture 574 which engages with the locating pin shown in the conventional slogging hammer.

In FIGS. 51 and 52 above, it will be appreciated that the roller bearings 580 to 584 are in bearing engagement with the unthreaded part 562 of the shank 560.

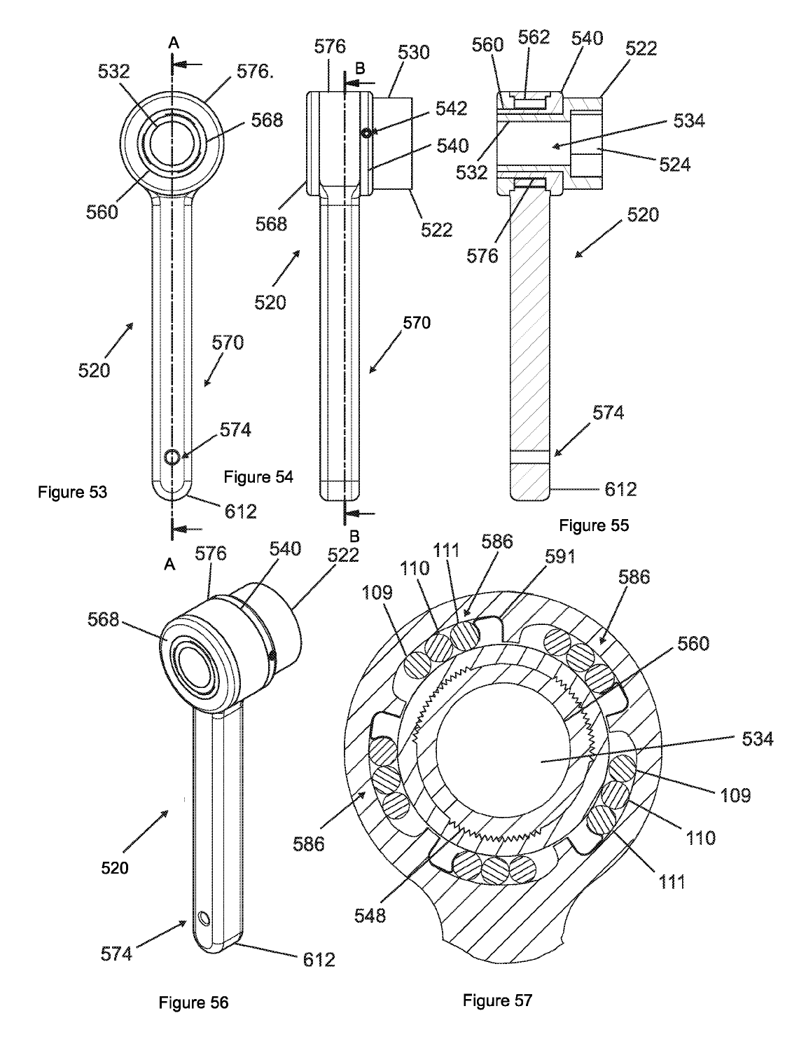

In FIGS. 53 to 57, there is shown an assembled view of the slogging spanner 520. It will be noted that, in contrast to the previous embodiments shown in FIGS. 31 to 48, the torque transmission assembly 596 has five sets of three roller bearings 614, 616 and 618, each of slightly decreasing diameter, and which are located in races or cavities 620, which are of similar shape to races or cavities 458 of the previous embodiment, and function in a similar manner as described in FIGS. 31 and 32.

In the following drawings, there is illustrated an embodiment of an apparatus, in the form of a multipurpose (slide hammer operated) dual end percussion apparatus 622 instead of the slogging hammer described above.

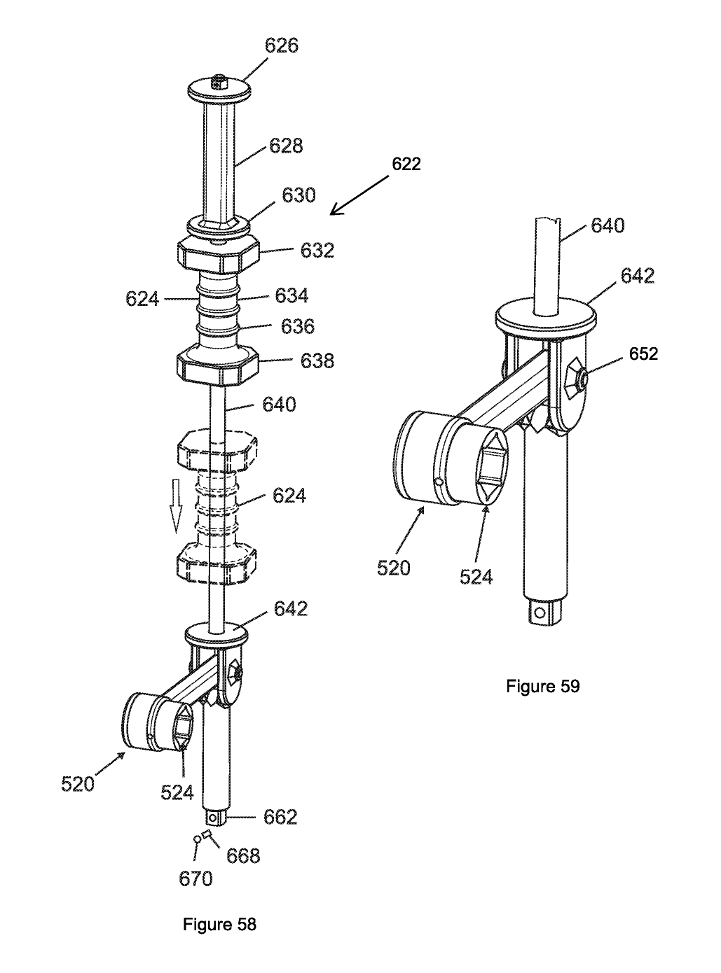

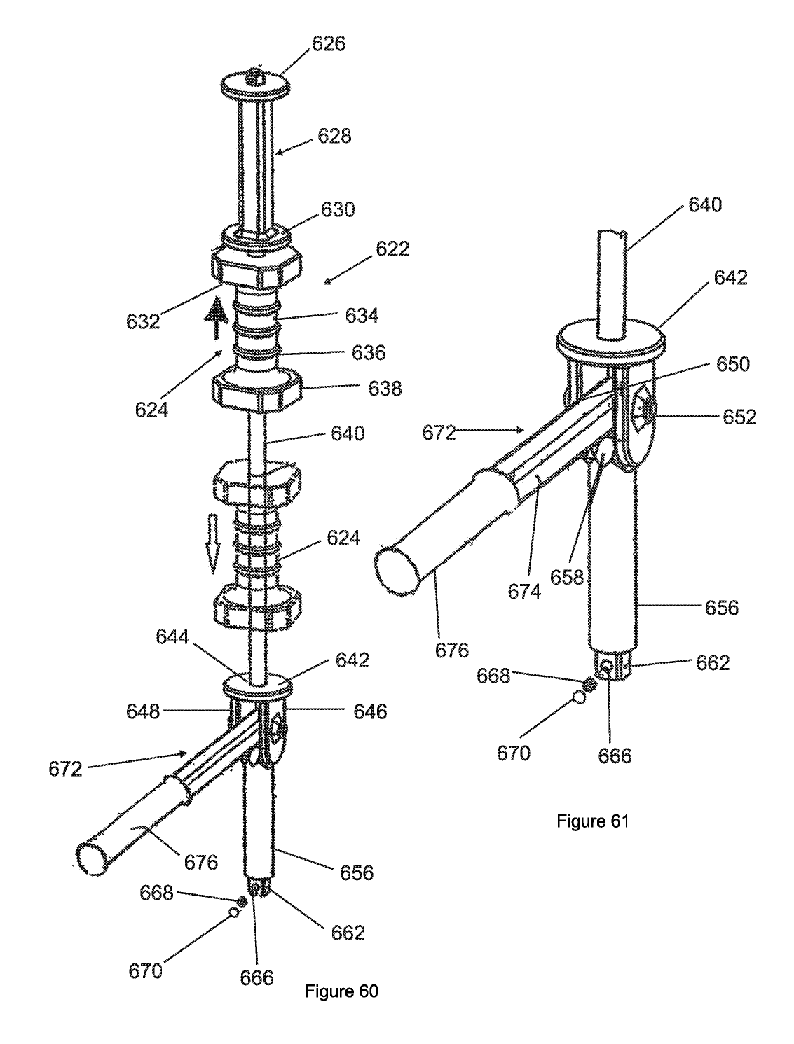

The tool 622 has a slide hammer 624, which includes stop/end plate 626, handgrip 628, stop/end plate/impact plate 630, weight 632, another handgrip 634, which has ridges 636 to facilitate gripping of the handgrip 634, and another weight 638. In FIG. 58, movement of the slide hammer 624 is shown in phantom which includes the weights 632 and 638 separated by the handgrip 634, wherein the handgrip 628 is held by one hand in a stationary position, and the slide hammer 624 moves along a support shaft 640 by the other hand gripping the handgrip 634. Movement of the phantom slide hammer 624 is shown by an arrow in full outline, shown moving in the direction to make contact with an impact plate 642. The slide hammer 624 is also shown in FIG. 60 moving in the direction indicated by the solid black arrow to make contact with the stop/impact plate 630.

As shown in FIGS. 58 and 59, the impact plate 642 is attached to the support shaft at 644. A pair of opposed plates 646 and 648 extend downward from the support plate 642. The plate 648 has a guide hole through which a locating or guide pin/bolt 650 extends. The bolt 650 through the aperture 574 of the slogging spanner 612 and is secured by the fastener 652. The multi-purpose, dual end percussion apparatus 622 also includes a downwardly extending shaft 656, which is attached to the end plates 646 and 648 at 658. The extended shaft 660 also has a spigot 662 and a ball 664, for engagement with the socket 464 as shown in FIG. 69. The spigot 662 has an aperture 666, which retains a spring 668 and a ball 670.

FIGS. 58 and 54 show the multi-purpose dual end percussion tool 622 connected with the slogging wrench 520. The stop 630 on the handgrip 628 is the second impact plate for the slide hammer 624 of the multi-purpose dual end percussion tool 622 when the slide hammer 624, connected to the weight 632, is directed with force to impact with stop 630. In this procedure, the shaft 656 serves as a second handgrip.

The other impact plate 642 impacts with the weight 638 on the slide hammer 624, shown drawn in phantom and arrow in phantom in FIG. 58, to strike the impact plate 642.

Note: should slide hammer 624 shown in different positions in FIG. 58 on the support shaft 640 be manufactured from copper or brass, then the multi-purpose dual end percussion tool 622 would comply for use in a hazardous working environment.

FIGS. 60 and 61 show the slogging spanner 520 disconnected from a location between the opposing plates 646 and 648 by withdrawing the bolt 650. A lever member 672 is connected in the same manner as the slogging spanner 520 shown in FIGS. 60 and 61.

The lever member 672, subject to a length of a shaft 674 and a handle/grip 676, when coupled with the multi-purpose dual end percussion apparatus 622, can have a reduction ratio from 10:1 to 30:1. This reduction ratio or leverage assists the user to substantially increase the torque by the reduction ratio percentage as stated above to rotate the socket 44 clockwise or anticlockwise when the socket 464 is connected with the spigot 662.

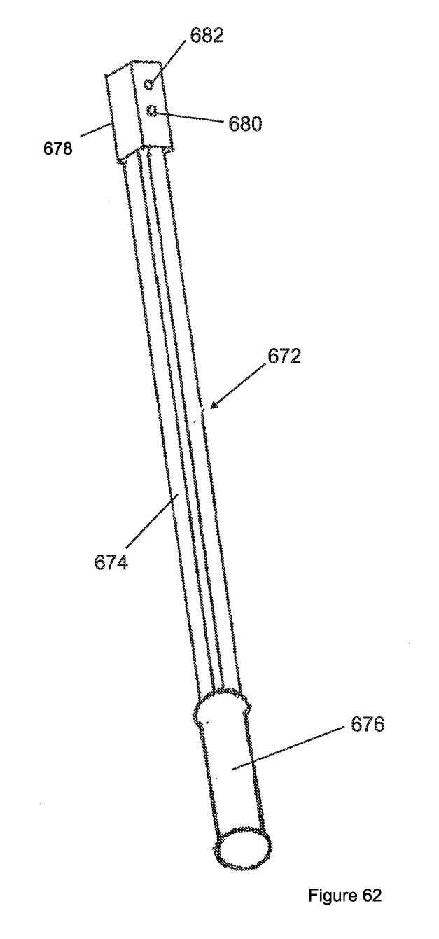

FIG. 62 shows the lever member 672 with the handle/grip 676, the shaft 674 and a head 678. The lever member 672 has a pair of apertures 680 and 682.

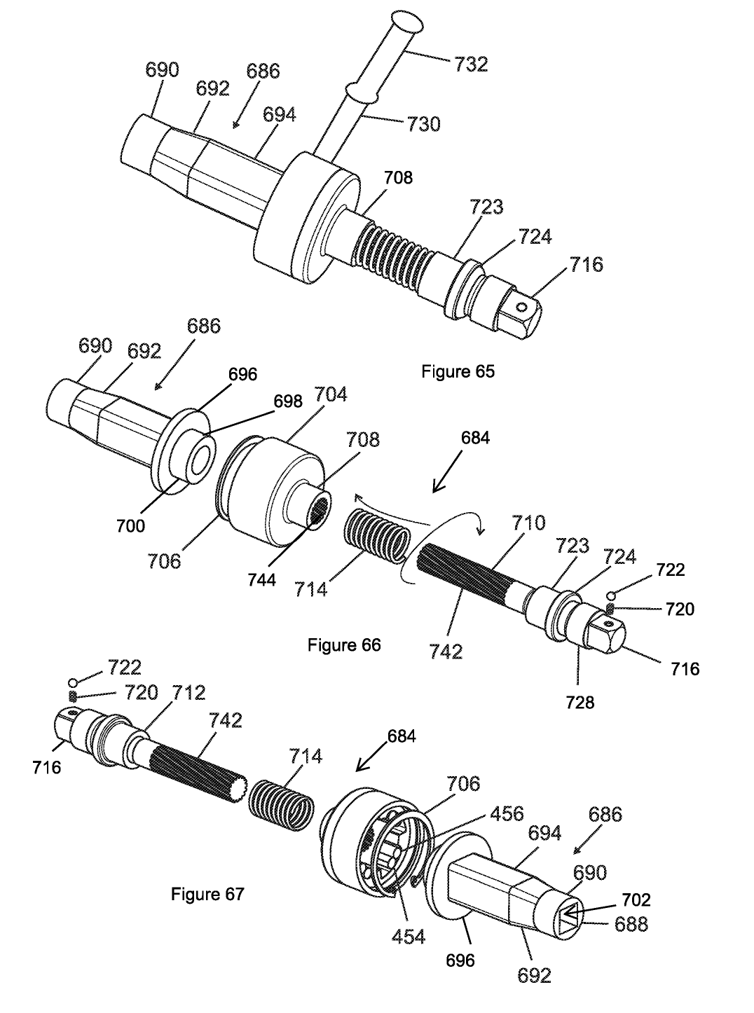

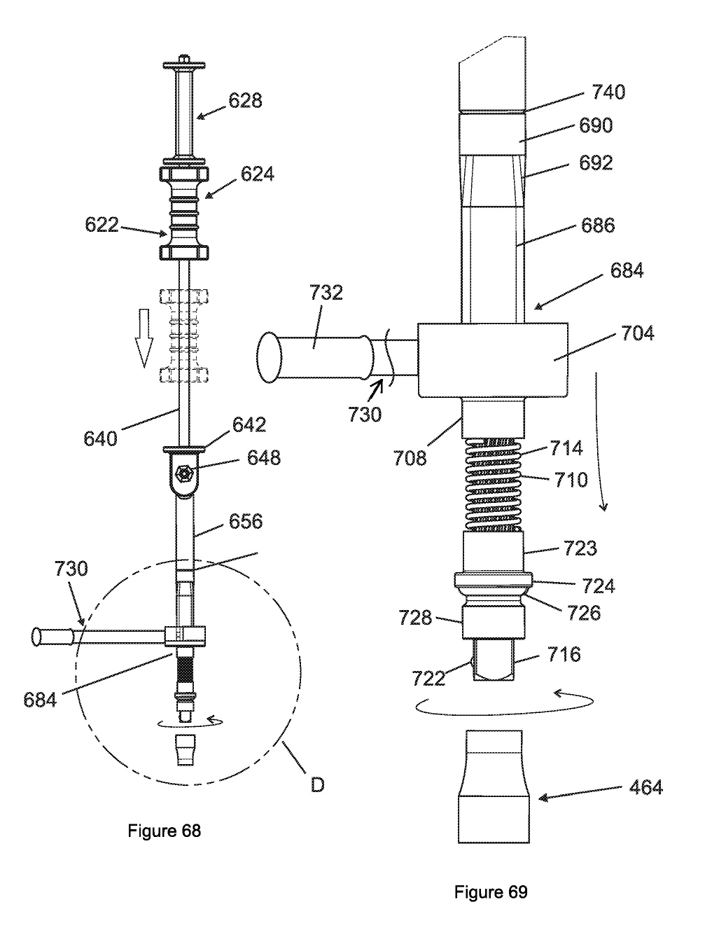

In FIGS. 65 to 67 there is shown an impact socket turning apparatus 684, which is connected to the multi-purpose dual end percussion apparatus 622 having the slide hammer 624 as shown in FIGS. 68 and 69. The impact socket turning apparatus 684 has a shaft 686 having a square female adapter 688 located in a rounded end part 690. There is also provided a tapered part 692, an elongate body 694, which has a flange 696 and a round protrusion 698 which has a bearing surface 700, and which locates in a hollow interior 702 of a torque transmission assembly 704.

Sets of roller bearings 454 and 456 are located in the hollow interior 702 and are separated by the projections 462. There are also provided the springs 460 and the races/cavities 458. It will be noted that the flange 696 fits within the hollow interior 702 and is retained by a circlip 706. There is also provided a splined spigot 708 which engages with a splined shaft 710 of an end component 712. There is also provided a helical spring 714 which surrounds a splined shaft 710. The end component 712 also has a spigot 716 having a blind hole 718 which retains a spring 720 and a ball 722 in the detent 466 of the socket 464 as shown in FIG. 69. The end component 712 also includes a round part 724, which retains the splined shaft 710 and also functions as a spring retainer for the helical spring 714. The splined spigot 708 also functions as the other retainer for the helical spring 714. The end component 712 also includes a flange 724 as well as a threaded part 726, which engages with a threaded component 728, which is contiguous with the spigot 708. Alternatively, the spigot 708, the component 728 and the part 726 may be an integral component with the part 726 screw-threaded to the flange 724.

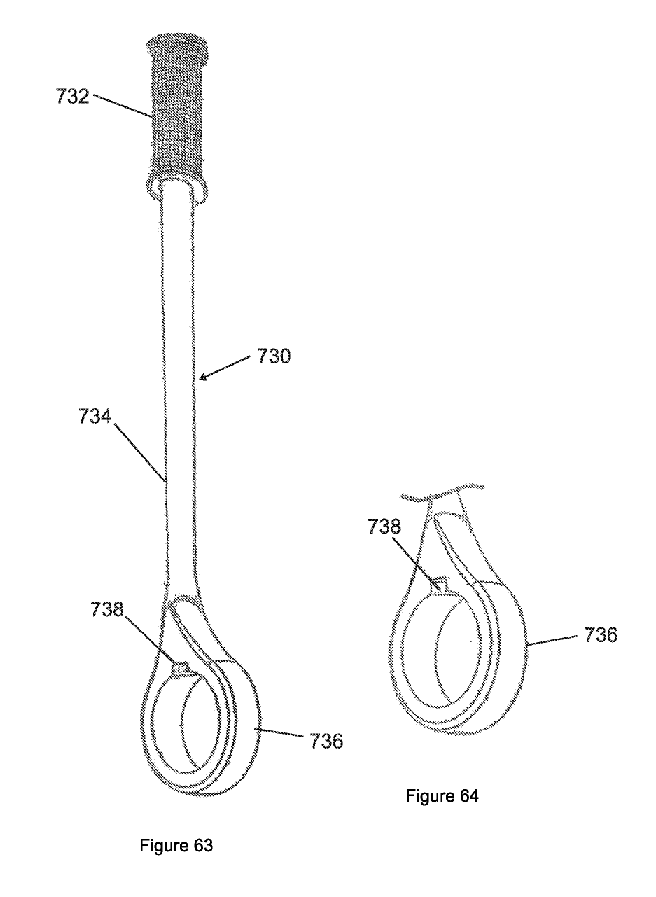

FIGS. 63 and 65 show a lever member 730 with a handle or grip 732, a shaft 734, a head 736 and a keyway 738.

FIGS. 66 and 67 show the torque transmission assembly 704 of the impact socket turning apparatus 684 disengaged with the lever member 730. The lever member 730, when coupled with the assembly 704, as shown in FIGS. 64 and 69, operates the assembly 704 of the impact socket turning apparatus 684 in the same manner as previously described for the handle 444.

The lever member 730, when connected with the assembly 704 of the impact socket turning apparatus 684, applies significant additional torque at a ratio of from 10:1 to 30:1, depending on a length of the shaft 734 and the handle or grip 732 to an adjacent nut or bolt (not shown) prior to, or at the same time as the nut or bolt is impacted from the slide hammer 624 in order to break the seal of the nut or bolt, and to rotate the nut or bolt in the same direction as applied to the lever member 730 by the user. The reverse of the procedure as described above is performed to tighten a nut or bolt but requires the impact socket turning apparatus 684 for this procedure.

FIGS. 68 and 69 show the slide hammer 624 drawn in phantom, positioned in the multi-purpose dual end percussion tool 622 moving in a direction to strike the impact plate 642. The slide hammer 624 impacts with the impact plate 642 and impacts the socket turning apparatus 684 to turn the socket or impact socket 464 anticlockwise.

In FIGS. 68 and 69, there is shown the multi-purpose, dual end percussion tool 622 and the impact socket turning apparatus 684 connected to each other at 740, wherein the spigot 662 engages with the square female adaptor 690 on the shaft 686 in a similar manner as described above for attachment of the spigot 716 to the socket 464. In this regard, the spigot 662 is provided with the ball 670, the blind hole 666 and the spring 668, the ball 670 and the spring 668 being retained in the blind hole 666.

It is also noted that the splined shaft 710 has splines 742 shown in FIG. 67, which mesh or connect with splines 744 of the spigot 708, to provide additional turning torque when the slide hammer 624 strikes the impact plate 642, causing the socket 464, coupled to the spigot 716, which forms part of the splined shaft 710, to be rotated with increased torque or thrust to turn or rotate a nut or bolt (not shown).

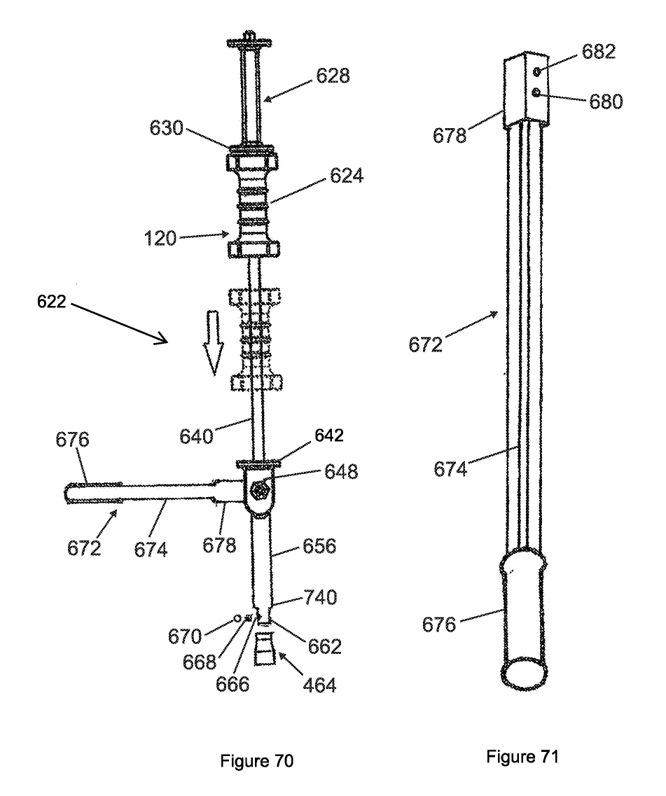

FIG. 70 shows a multi-purpose, dual-end percussion tool 622, with the slide hammer 624 in phantom moving in a direction to strike the impact plate 642. The lever member 672 is shown attached between opposed plates 646 and 648. The guide pin or bolt 650 is located and extends between each plate 646 and 648 and is fastened at 650. The guide pin or bolt 650 extends through either of the apertures 680 or 682 of the lever member 672, with the lever member 672 secured in position between the opposed plates 646 and 648 by the guide pin or bolt 650 as shown on plate 648.

In the specification, the use of the word “roller bearing” is intended to be in a broad sense, and relates to the appearance of the roller bearing as opposed to its use which, as will be clear from the specification, is not necessarily as a conventional roller bearing.

In the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

The use of words that indicate orientation or direction of travel is not to be considered limiting. Thus, words such as “front”, “back”, “rear”, “side”, “up”, down”, “upper”, “lower”, “top”, “bottom”, “forwards”, “backwards”, “towards”, “distal”, “proximal”, “in”, “out” and synonyms, antonyms and derivatives thereof have been selected for convenience only, unless the context indicates otherwise. The inventor envisages that various exemplary embodiments of the claimed subject matter can be supplied in any particular orientation and the claimed subject matter is intended to include such orientations.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:

a. there is no requirement for the inclusion of any particular described or illustrated characteristic, function, activity, or element, any particular sequence of activities, or any particular interrelationship of elements;
b. no characteristic, function, activity, or element is “essential”;
c. any elements can be integrated, segregated, and/or duplicated;
d. any activity can be repeated, any activity can be performed by multiple entities, and/or any activity can be performed in multiple jurisdictions; and
e. any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate sub-range defined by such separate values is incorporated into the specification as if it were individually recited herein. For example, if a range of 1 to 10 is described, that range includes all values there between, such as for example, 1.1, 2.5, 3.335, 5, 6.179, 8.9999, etc., and includes all sub-ranges there between, such as for example, 1 to 3.65, 2.8 to 8.14, 1.93 to 9, etc.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. A reversible wrench that comprises
a handle;
a carrier arranged on the handle; and
a torque transmission assembly arranged in the carrier, the assembly including
an inner driven member having an inner, outwardly facing bearing surface and an outer driving member having an outer, inwardly facing bearing surface, the driven and driving members being arranged in the carrier about a common rotation axis and the surfaces being spaced from each other;
a selector positioned between the bearing surfaces;
at least one motion transfer device positioned between the bearing surfaces, the bearing surfaces, the selector and the at least one motion transfer device defining at least two roller bearing passages;
at least one roller bearing positioned in each passage, the bearing surfaces of each passage being profiled so that the roller bearings can be shifted between a tightening condition in which the roller bearings lock the bearing surfaces together for tightening rotation of the carrier and a loosening condition in which the roller bearings lock the bearing surfaces together for loosening rotation of the carrier and such that opposite rotation of the carrier with respect to the tightening and the loosening rotation, respectively, unlocks the roller bearings to permit freewheeling of the carrier with respect to the inner driving member during the opposite rotation; and
the selector and the at least one motion transfer device are configured so that the selector is operable to shift the roller bearings between the tightening and loosening conditions, via the at least one motion transfer device, a biasing mechanism being operatively arranged with respect to the roller bearings and configured so that the roller bearings are unlocked against a bias of the biasing mechanism during the opposite rotation and are driven back into one of the tightening and loosening conditions upon ceasing of the opposite rotation.

2. The reversible wrench as claimed in claim 1, in which the selector includes a shifting member that is interposed between two passages and displaceable in clockwise and anticlockwise directions, the biasing mechanism being arranged on the shifting member.

3. The reversible wrench as claimed in claim 2, in which the biasing mechanism includes a spring arranged on each side of the shifting member to bear against a roller bearing in each of the two passages such that displacement of the shifting member in either a clockwise or an anticlockwise direction results in the roller bearings being shifted into the tightening or loosening conditions.

4. The reversible wrench as claimed in claim 1, in which the, or each, motion transfer device includes a spacer that is configured to fit between the bearing surfaces and that is shaped so that movement of the spacer as a result of operation of the selector is stabilised.

5. The reversible wrench as claimed in claim 4, in which the, or each, spacer is configured to act on adjacent roller bearings, while maintaining the roller bearings in a position in which rotational axes of the roller bearings are substantially parallel to the common axis of rotation of the inner and outer bearing surfaces.

6. The reversible wrench as claimed in claim 4, in which the, or each, spacer includes a spacer block having an arcuate cross section to accommodate arcuate, reciprocal movement of the spacer block between the inner and outer bearing surface surfaces.

7. The reversible wrench as claimed in claim 6, in which the, or each, spacer includes a biasing mechanism that is arranged on each axial side of the spacer block, the biasing mechanism of the spacer being configured to act on the adjacent roller bearings, together with the biasing mechanism of the selector to facilitate maintenance of the roller bearings and the, or each, spacer, in a contiguous relationship.

8. The reversible wrench as claimed in claim 6, in which the biasing mechanism includes at least one spring arranged on each side of the spacer block to act on the adjacent roller bearings.

9. The reversible wrench as claimed in claim 1, in which a plurality of roller bearings of varying diameter from a largest to a smallest are positioned, in decreasing size order, in at least one respective passage, at least one of the bearing surfaces of the at least one respective passage defining at least one involute plan profile with reference to the common rotation axis and the at least one involute plan profile being configured such that the plurality of roller bearings can shift into a tightening or loosening condition in which the roller bearings engage each other and the inner and outer bearing surfaces.

10. The reversible wrench as claimed in claim 9, in which the inner bearing surface is circular cylindrical and the outer bearing surface defines the at least one involute plan profile.

11. The reversible wrench as claimed in claim 9, in which the bearing surfaces, the selector and the motion transfer devices define three circumferential roller bearing passages, in the form of a left-hand passage, a right-hand passage and an intermediate passage, when viewed proximally, the intermediate passage being interposed between the left and right hand passages.

12. The reversible wrench as claimed in claim 11, in which the left and right hand passages each have the plurality of roller bearings and the at least one involute plan profile, with the left and right hand passages being symmetrical so that the roller bearings in one of the left and right hand passages can move into the tightening or loosening condition while the bearings in another of the left and right hand passages can move out of the tightening or loosening condition, the intermediate passage having at least one roller bearing capable of shifting between the tightening and loosening conditions in the intermediate passage.

13. The reversible wrench as claimed in claim 12, in which the bearing surfaces are profiled so that a largest bearing in each of the left and right passages is capable of seating in a respective end of the left and right passages so that, during the opposite rotation, the largest bearings can rotate, roller bearing fashion, in the respective left and right passages.

14. The reversible wrench as claimed in claim 13, in which the bearings in the intermediate passage include an odd number of bearings with a middle, largest bearing and the bearing surfaces of the intermediate passage being configured so that the middle largest bearing can rotate, in a conventional roller bearing fashion, during the opposite rotation.

15. The reversible wrench as claimed in claim 9, in which the bearing surfaces, the selector and the motion transfer devices define two circumferential roller bearing passages, in the form of a left-hand passage and a right-hand passage, when viewed proximally.

16. The reversible wrench as claimed in claim 15, in which the left and right hand passages each have the plurality of roller bearings and the at least one involute plan profile with the left and right hand passages being symmetrical so that the roller bearings in one of the left and right hand passages move into a tightening or loosening condition while the bearings in another of the left and right hand passages move out of a tightening or loosening condition.

17. The reversible wrench as claimed in claim 16, in which the bearing surfaces are profiled so that a largest bearing in each of the left and right passages is capable of seating in a respective end of the left and right passages so that, during the opposite rotation, the largest bearings can rotate, roller bearing fashion, in the respective left and right passages.

18. The reversible wrench as claimed in claim 1, in which the bearing surfaces of at least one passage are profiled so that at least two roller bearings of substantially equal diameter can be received in the at least one passage and so that the roller bearings can be shifted between the tightening and loosening conditions.

19. The reversible wrench as claimed in claim 18, in which the bearing surfaces of the at least one passage are profiled so that the roller bearings can shift a predetermined extent between a position in which the roller bearings are contiguous and centrally positioned in the at least one passage and a position in which the roller bearings are in either of the tightening and loosening conditions.

20. The reversible wrench as claimed in claim 1, in which the inner driven member is a hub capable of engagement with a socket adaptor so that rotation of the hub can result in rotation of the socket adaptor.

21. The reversible wrench as claimed in claim 1, in which the driving member is a cup member with a cup wall that defines the outer bearing surface.

22. The reversible wrench as claimed in claim 1, in which the driving member and the carrier are in the form of a unitary, one-piece construction.

23. The reversible wrench as claimed in claim 1, in which the driving member and the carrier are configured so that the driving member can be mounted in the carrier.

24. The reversible wrench as claimed in claim 23, in which the driving member and the carrier are configured so that the driving member can be press-fitted into the carrier, the carrier and the driving member having corresponding non-circular profiles to inhibit relative rotation of the carrier and the driving member.

25. The reversible wrench as claimed in claim 24, in which the handle and the carrier are of a one-piece, unitary construction of one material and the torque transmission assembly is of a different material.

26. The reversible wrench as claimed in claim 25, in which the handle and the carrier are of one of an aluminium alloy and an anodised aluminium, and the torque transmission assembly is of steel.

27. A torque transmission assembly that comprises
an inner driven member having an inner, outwardly facing bearing surface and an outer driving member having an outer, inwardly facing bearing surfaces, the driven and driving members being configured for mounting in a suitable carrier, about a common rotation axis, the surfaces being spaced from each other;
a selector positioned between the bearing surfaces;
at least one motion transfer device positioned between the bearing surfaces, the bearing surfaces, the selector and the at least one motion transfer device defining at least two roller bearing passages;
at least one roller bearing positioned in each passage, the bearing surfaces of each passage being profiled so that the roller bearings can be shifted between a tightening condition in which the roller bearings lock the bearing surfaces together for tightening rotation of the carrier and a loosening condition in which the roller bearings lock the bearing surfaces together for loosening rotation of the carrier and such that opposite rotation of the carrier with respect to the tightening and the loosening rotation, respectively, unlocks the roller bearings to permit freewheeling of the carrier during the opposite rotation; and
the selector and the at least one motion transfer device are configured so that the selector is operable to shift the roller bearings between the tightening and loosening conditions, via the at least one motion transfer device, a biasing mechanism being operatively arranged with respect to the roller bearings and configured so that the roller bearings are unlocked against a bias of the biasing mechanism during the opposite rotation and are driven back into one of the tightening and loosening conditions upon ceasing of the opposite rotation.
